(19) United States
(12) Patent Application Publication
(10) Pub. No.: US 2006/0040239 A1
(43) Pub. Date: Feb. 23, 2006

(54) Driving simulator having articial intelligence profiles, replay, hazards, and other features

(75) Inventors: Robert L. Cummins, Oshkosh, WI (US); John J. Garvey, Black Creek, WI (US); Robert C. Halla, Appleton, WI (US); Keith D. Keller, Neenah, WI (US); Tim Miller, Appleton, WI (US); Doraivelu Arasur Palanivelu, Appleton, WI (US); Sukhdev Singh Tur, New Berlin, WI (US); Steven W. Velpel, Appleton, WI (US); Jeff Weber, Appleton, WI (US); Joel A. Williams, Greenville, WI (US)

Correspondence Address: MICHAEL BEST & FRIEDRICH, LLP, 100 E WISCONSIN AVENUE, MILWAUKEE, WI, 53202, US

(73) Assignee: J. J. Keller & Associates, Inc., Neenah, WI (US)

(21) Appl. No.: 10/910,019

(22) Filed: Aug. 2, 2004

(51) Int. Cl. G09B 9/04; G09B 19/16

(52) U.S. Cl. 434/62

(57) ABSTRACT

A driving simulator. The driving simulator may include a processor; a display connectable to the processor; a plurality of input devices, such as a steering wheel, a brake pedal, and an accelerator pedal, where each of the plurality of input devices is connectable to the processor; and a computer-readable medium. The computer-readable medium contains instructions for providing a plurality of simulated driving environments, allowing a user to select one of the plurality of simulated driving environments, allowing a user to provide environment settings, allowing a user to select a simulated vehicle to operate, activating hazards, generating a plurality of simulated vehicles, generating a profile for each of the plurality of simulated intelligent vehicles; randomly assigning spawn points to each of the plurality of simulated intelligent vehicles, displaying the simulated driving environment to a user and allowing the user to operate the simulated vehicle in the simulated driving environment using the plurality of input devices, recording the operation of the simulated vehicle through the simulated driving environment, and replaying the operation of the vehicle.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Embodiments of the invention relate to methods and systems for training drivers of trucks and other vehicles.

There are a variety of vehicle simulators including advanced systems that include mock vehicle interiors that are mounted on articulated platforms that can be moved in a manner that simulates motions experienced in an actual vehicle. In general, such simulators also include one or more large screen displays. Of course, while not generally used as training tools, there are also a variety of video games that provide driving simulation. Generally, video game simulations are not related to ordinary or real-world driving situations. Instead, they generally present a racing environment, a fantasy environment, or a combination of the two.

### SUMMARY OF THE INVENTION

While there are numerous driving simulators available, the inventors have determined that many of them are deficient. Advanced simulators are, in general, expensive, large, and difficult to transport. Often they are built for very specific purposes. For example, such simulators are often designed to provide training on either one or a limited number of vehicles. In contrast to many simulators, video games are cheap. However, video games are not, in general, useful for the purposes of training drivers. The inventors have also determined that simulators often provide minimum or limited feedback during and after the operation of the simulator.

Accordingly, some embodiments of the invention provide a driving simulator including a processor operable to fetch instructions from computer-readable medium and execute the instructions; a display connectable to the processor; and input devices, including a steering wheel, a brake pedal, and an accelerator pedal, where each of the plurality of input devices is connectable to the processor. The processor executes a computer-readable medium containing instructions for providing a plurality of simulated driving environments, allowing a user to select one of the plurality of simulated driving environments, allowing a user to provide environment settings, allowing a user to select a simulated vehicle to operate, activating hazards, generating a plurality of simulated vehicles, generating a profile for each of the plurality of simulated intelligent vehicles; randomly assigning spawn points to each of the plurality of simulated intelligent vehicles, displaying the simulated driving environment to a user and allowing the user to operate the simulated vehicle in the simulated driving environment using the plurality of input devices, recording the operation of the simulated vehicle through the simulated driving environment, and replaying the operation of the vehicle.

Additional embodiments provide a method of generating a simulated driving environment. The method includes generating a route; generating one or more trips for the route; generating one or more trip segments for the one or more trips; creating a hazard;
specifying a spawn point for the hazard; and adding the hazard to at least one of the one or more trip segments.

Yet another embodiment provides a method of providing a simulated driving environment. The method includes selecting a route; selecting a trip available in the route; creating an environment profile specifying the environment of the trip; selecting a vehicle to operate; operating the vehicle on the selected trip; recording the operation of the vehicle on the selected trip; and replaying the operation of the vehicle on the selected trip.

Another embodiment provides a system for training a driver. The system includes a plurality of input devices, including at least a steering wheel, a brake pedal, and an accelerator pedal, where each of the plurality of input devices is connectable to a processor. The processor is configured to execute a computer-readable medium that contains instructions for providing a plurality of simulated driving environments, allowing a user to select one of the plurality of simulated driving environments, allowing a user to provide environment settings, allowing a user to select a simulated vehicle to operate, activating hazards, generating a plurality of simulated vehicles, generating a profile for each of the plurality of simulated intelligent vehicles; randomly assigning spawn points to each of the plurality of simulated intelligent vehicles, displaying the simulated driving environment to a user and allowing the user to operate the simulated vehicle in the simulated driving environment using the plurality of input devices, recording the operation of the simulated vehicle through the simulated driving environment, and replaying the operation of the vehicle.

Other embodiments provide a system for administrating the training of a plurality of drivers. The system includes one or more client computers configured to execute a driving simulator, to log operational data of the executed driving simulator, and to provide a data storage device with the operational data; the data storage device configured to receive the operational data of the driving simulator from one or more client computers, to store the operational data, and to provide access to the operational data by an administrative computer; the administrative computer configured to access the operational data, to specify a camera angle, to replay the operational data, and to modify the camera angle.

Another embodiment provides a computer readable medium. The computer readable medium contains instructions for providing a plurality of simulated driving environments, allowing a user to select one of the plurality of simulated driving environments, allowing a user to provide environment settings, allowing a user to select a simulated vehicle to operate, activating hazards, generating a plurality of simulated vehicles, generating a profile for each of the plurality of simulated intelligent vehicles; randomly assigning spawn points to each of the plurality of simulated intelligent vehicles, displaying the simulated driving environment to a user and allowing the user to operate the simulated vehicle in the simulated driving environment using the plurality of input devices, recording the operation of the simulated vehicle through the simulated driving environment, specifying a camera angle; replaying the operation of the vehicle; and modifying the camera angle.

Additional embodiments provide a module for managing a plurality of intelligent vehicles in a driving simulator. The module includes a vehicle list specifying the plurality of intelligent vehicles where each vehicle has a profile, a state, and a mesh; a profile list specifying a vehicle type for each of the plurality of intelligent vehicles; a random number generator configured to generate random spawn points; a spawn point list specifying a random spawn point for each of the plurality of intelligent vehicles; and a timer configured to track the operational time of each of the plurality of intelligent vehicles.

Another embodiment provides a driving simulator. The driving simulator includes an administrative module configured to access and review the operation of the driving simulator and to configure the driving simulator; a graphics and sound rendering application configured to create and provide visual and audio data; a history database configured to store operational data of the driving simulator; an administrative database configured to store settings and configurations generated by the administrative module for operating the driving simulator; a route database configured to store routes generated by the administrative module; a tool module configured to provide modifying tools accessed by the administrative module; a player module configured to replay stored operational data; a simulation module configured to initiate and display a simulated driving environment and simulated vehicle; and a manager module configured to manage the objects of the driving simulator, to record operational data, and to provide an interface to the graphics and sound application.

Embodiments also provide a method of training a driver. The method includes operating a simulated vehicle through a simulated driving environment; recording the operation of the simulated vehicle through a simulated driving environment; specifying a camera angle; replaying the operation of a simulated vehicle through the simulated driving environment; and modifying the camera angle.

Another embodiment provides a method of simulating a driving environment. The method includes displaying a direct view of a simulated driving environment in a direction; and displaying one or more mirror views with the direct view upon indication by a user without modifying the first direction of the direct view.

Yet another embodiment provides a method of training a driver. The method includes selecting a driver; assigning a vehicle to the driver; assigning a driving environment to the driver; activating one or more hazards; specifying a likelihood of occurrence for each of the one or more hazards; selecting a difficulty level for each of the one or more hazards; selecting an atmosphere; and specifying an aggression profile for a plurality of simulated intelligent vehicles.

Other embodiments also provide a method for analyzing the operational data collected by a driving simulator. The method includes storing the operational data in a storage device; receiving report parameters from a user, wherein the user specifies a type of report including an individual trip report, a trip summary report, or a driver summary report; obtaining the operational data from the storage device; generating a report from the operational data; and displaying the report to the user.

Other features and aspects of embodiments of the invention will become apparent to those skilled in the art upon review of the following detailed description, claims, and drawings.

### BRIEF DESCRIPTION OF THE DRAWINGS

In the drawings:

FIG. 1 illustrates an exemplary driving simulator.

FIG. 2 illustrates an exemplary architecture of a driving simulator.

FIG. 3 is an exemplary class diagram illustrating a plurality of manager classes utilized by a driving simulator.

FIG. 4 is an exemplary entity/relationship diagram illustrating relationships of objects of a driving simulator.

FIG. 5 is an exemplary class diagram illustrating a plurality of classes interacting with a vehicle artificial intelligence manager class.

FIG. 6 is a flow chart illustrating an exemplary process of operating an artificial intelligence vehicle.

FIG. 7 is another flow chart illustrating an exemplary process of operating an artificial intelligence vehicle.

FIG. 8 is an exemplary class diagram illustrating a plurality of classes interacting with a hazard manager class.

FIGS. 9-19 are screen shots of exemplary output displayed when configuring a driving simulator.

FIG. 20 is a screen shot of an exemplary simulated driving environment.

FIG. 21 is a screen shot of an exemplary simulated driving environment including a mirror view.

FIG. 22 is a screen shot of an exemplary simulated driving environment including a split screen displaying a direct view and a mirror view.

FIG. 23 is another screen shot of an exemplary simulated driving environment including a split screen displaying a direct view and a mirror view.

FIG. 24 is a screen shot of an exemplary simulated driving environment with simulated weather effects.

FIGS. 25-28 are screen shots of an exemplary simulated driving environment including a hazard.

FIG. 29 is a screen shot of an exemplary accident report.

FIGS. 30-32 are screen shots of exemplary output displayed when analyzing performance of a driver when operating a driving simulator.

FIG. 33 is an exemplary trip report.

FIGS. 34-36 are screen shots of an exemplary simulated driving environment during replay.

FIG. 37 is an exemplary screen shot of an exemplary editing application configured to generate and modify simulated driving environments.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

### DETAILED DESCRIPTION

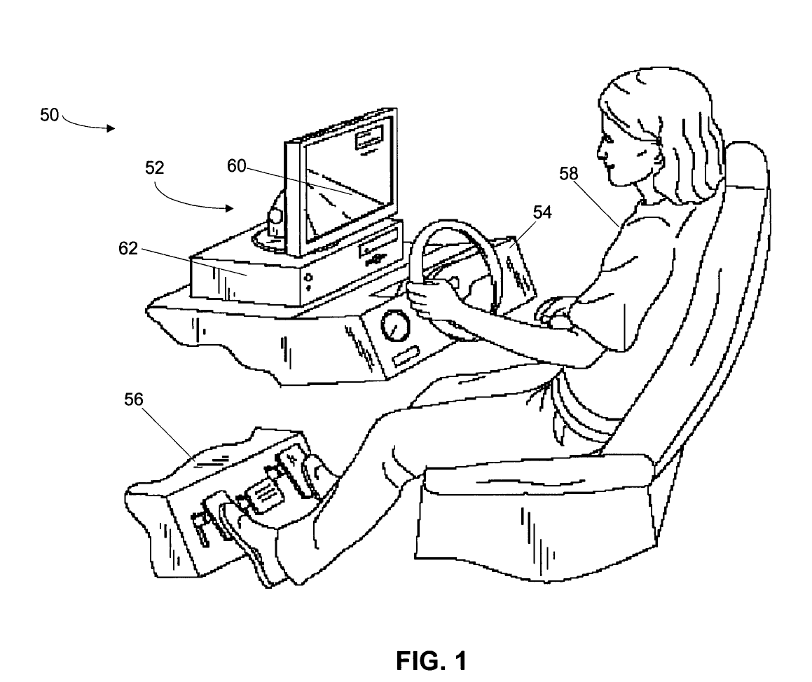

FIG. 1 illustrates an exemplary driving simulator 50. The simulator 50 includes a workstation 52, a steering wheel input device 54, and a pedal input device 56. The workstation 52 includes a display 60 configured to provide graphical and textual images to a user 58. The workstation 52 may include more than one display 60. In some embodiments, multiple displays are used to simulate multiple views to a user 58. For example, one display may provide a front view while additional displays provide a right and left side view. The display 60 may also be embodied as a headset or virtual reality goggles, where the images are displayed on a screen worn by the user 58. The user 58 may be a vehicle operator or employee of a vehicle operation company, an administrator or trainer, or any individual desiring to setup, configure, operate, or analyze simulated driving.

The workstation 52 may include a processor 62 configured to fetch instructions from a computer-readable medium and execute the instructions. The processor may be connectable to the display 60 and may execute instructions that cause images to be rendered on the display 60. The processor 62 may be directly connected to the display 60 or may be connected indirectly through a network such as a local area network (“LAN”) or the Internet. The processor 62 may be connected to the display 60 through a wired or wireless connection.

In some embodiments, the processor 62 executes instructions for simulating a driving environment and the user 58 uses the steering wheel input device 54 and the pedal input device 56 to simulate driving a vehicle. It should be understood that the processor 62 may be configured to execute instructions for simulating the operation of other machinery besides vehicles. For example, the processor 62 may execute instructions simulating the operation of a forklift, a crane, or the like. Likewise, additional or alternative input devices may be utilized to simulate the operational controls of machines other than vehicles, such as forklift or crane controls. The steering wheel input device 54 may further include a gear shift, directional light levers or buttons, headlight controls, windshield wipers controls, mirror selection controls, or the like. The pedal input device 56 may include brake and accelerator pedals as well as a third pedal to simulate a clutch pedal used in vehicles with a manual transmission. Separate input devices may also be utilized that provide these controls. Additional controls such as an emergency brake, radio controls, or the like may also be included. A scan tracking input device may also be utilized to follow the head and eye movement of the user 58 and adjust the image displayed on the display 60 accordingly. The workstation 52 may also include speakers that provide audio feedback to the user 58 as well.

The input devices 54 and 56 provide signals to the processor 62 indicating their movement or position, broadly referred to as “use” by the user 58. The processor 62 uses the signals to modify the simulated driving environment, including a simulated vehicle, displayed on the display 60. For example, if the user 58 turns the steering wheel input device 54 to the left, the simulated vehicle in the simulated driving environment moves toward the left, as would an actual vehicle.

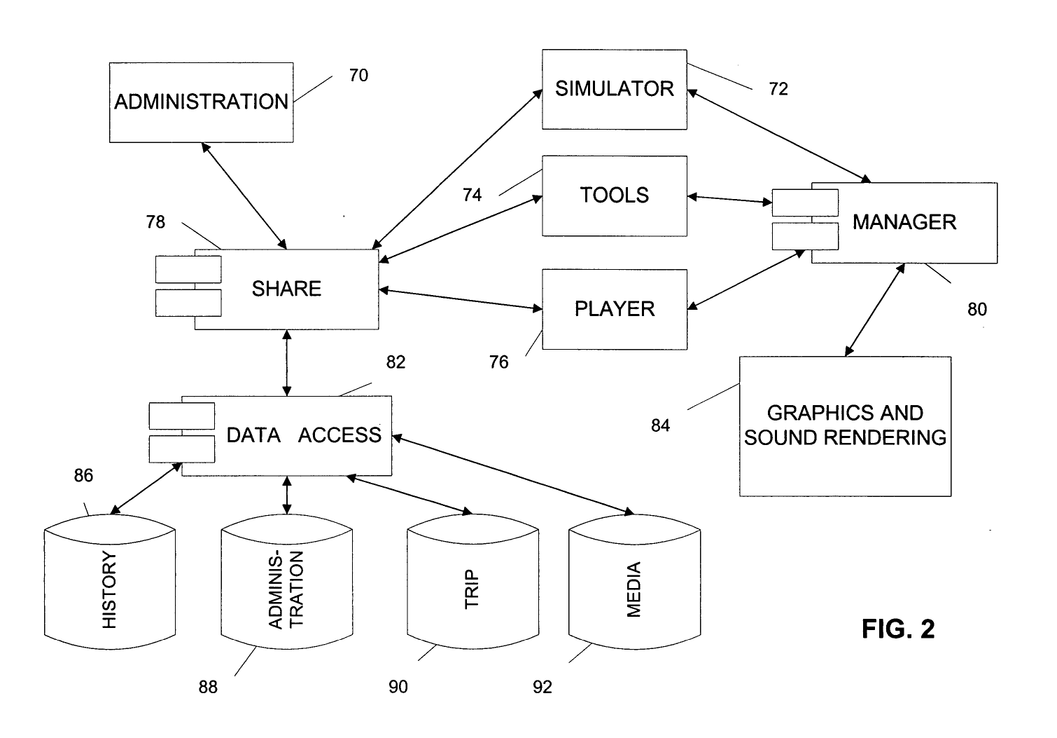

FIG. 2 illustrates an exemplary application architecture for the driving simulator 50. The architecture includes an administration module 70, a simulator module 72, a tools module 74, a player module 76, a share module 78, a manager module 80, a data access module 82, and a graphics and sound rendering module 84. The architecture further includes a history database 86, an administration database 88, a trip database 90, and a media database 92. The administration module 70 may be configured to access and perform various administrative functions such as adding and authenticating users. In some embodiments, lists of users authenticated to use the driving simulator 50 may be stored in the administration database 88. User names and passwords may be stored and used by the administration module 70 to authenticate users. The administration module 70 may also be configured to create simulated vehicles and trips that may be stored in the trip database 90. The administration module 70 may utilize a vehicle or trip editor tool provided by the tools module 74 to create or modify vehicles and trips. Scenery and background images such as trees, billboards, or the like, generated with the trip editor tool may be stored in the media database 92 where they can be reused in multiple trips.

The administration module 70 may also be configured to assign vehicles and trips to users and review performance data collected from the assigned user trips. Using the users defined in the administration database 88 and the vehicles and trips defined in the trip database 90, the administration module 70 may assign a particular user to operate the driving simulator 50 with a particular vehicle and on a particular trip. Assignments may be stored in the administration database 90. After a user has performed their assigned trip, the administration module 70 may allow the user 58 to review performance or operational data collected while the user performed the simulated trip. The performance data may be stored in the history database 86.

The data access module 82 may be configured to provide a common interface to the databases utilized by the driving simulator 50. However, the data access module 82 is not required. The interfacing capability it provides may be provided to each component that accesses one of the databases.

It should be understood that the configuration of the history database 86, administration database 88, trip database 90, and media database 92 may be modified. Databases may be combined or additional databases may be added. For example, the trip database 90 may be combined with the media database 92, the history database 86 may be combined with the administration database 88, or an additional database may be added to hold trip and vehicle assignments.

The simulator module 72 is configured to obtain configuration parameters and settings, and initiate a simulated driving environment. During operation of the driving simulator 50, the simulator module 72 interacts with the manager module 80, which is configured to control components of the driving simulator 50. In particular, the manager module 80 provides managing functionality for the graphics and sound rendering module 84. By using the manager module 80, the simulator module 72 can relinquish control of the graphics and sound rendering module 84. The graphics and sound rendering module 84 may consist of many components. For example, the graphics and sound rendering module 84 may consist of a physics engine such as the Open Dynamics Engine (“ODE”), a graphics engine such as DirectX available from Microsoft Corporation, and a game engine such as TrueVision available from TrueVision3d, LLC. Because management of graphics and sound rendering is handled by a separate entity (the manager module 80) components of the graphics and sound rendering module 84 may be changed and updated as technology progresses. The manager module 80 provides an abstraction to the simulator module 72 that allows components of the driving simulator 50 to be changed and modified without extensive changes to the simulator module 72.

The manager module 80 may further include other managerial components as will be discussed below.

While the user 58 operates the driving simulator 50 and drives a simulated vehicle through a simulated driving environment, the driving simulator 50 may be configured to record the operation by the user 58. The data recorded may be used by the player module 76 to replay the simulated driving on the display 60 for the user 58. For example, the player module 76 may record every three frames displayed on the display 60 while the user 58 operates a simulated vehicle in a simulated driving environment. The player module 76 uses the recorded frames to reconstruct and replay the performed simulated drive to the user 58 on the display 60. In some embodiments, the player module 76 may record a trip time point with each frame and, during replay, the player module 76 may allow the user 58 to jump to specific time points of the simulated trip. The player module 76 may also allow the user 58 to pause, rewind, or fast forward the replay. In some embodiments, the player module 76 also allows the user 58 to view the replay in slow motion.

The player module 76 may also record status information with the recorded frames, such as whether or not the brake or accelerator pedal was pressed, whether controls were activated such as headlights or windshield wipers, whether the user 58 checked the vehicle's mirrors, or the like. The status information may be displayed by the player module 76 during the replay to assess whether the user 58 starting braking early enough, whether the user 58 turned on lights or windshield wipers when needed, or the like.

The player module 76 may also be configured to replay the recorded frames from a number of camera angles. When the frames are recorded during the simulated driving, the frames have a front view similar to a view the user 58 acquires when driving an actual car. The player module 76 may, however, allow the user 58 to specify a camera angle that the replay should be displayed with, such as an overhead view, a side view, a back view, or the like. In some embodiments, the player module 76 allows the user 58 to change the camera angle in real-time while the replay is being displayed. The ability to dynamically adjust the camera angle allows the replay to provide beneficial and specific feedback for particular sections of the trip. For example, the user 58 may specify a side or back view when watching the user's 58 performance during a turn.

The share module 78 may be utilized in some embodiments of the invention to create cohesive and modular components. Functionality utilized by a number of the modules in the architecture may be placed in the share module 78 where it can be accessed by the components or modules that need it. The share module 78 allows modifications, additions, and deletions to be made at a central location rather than within a number of modules. It should be understood that the share module 78 may be eliminated from the architecture and the functionality it provides may be replicated and distributed among the other components as needed.

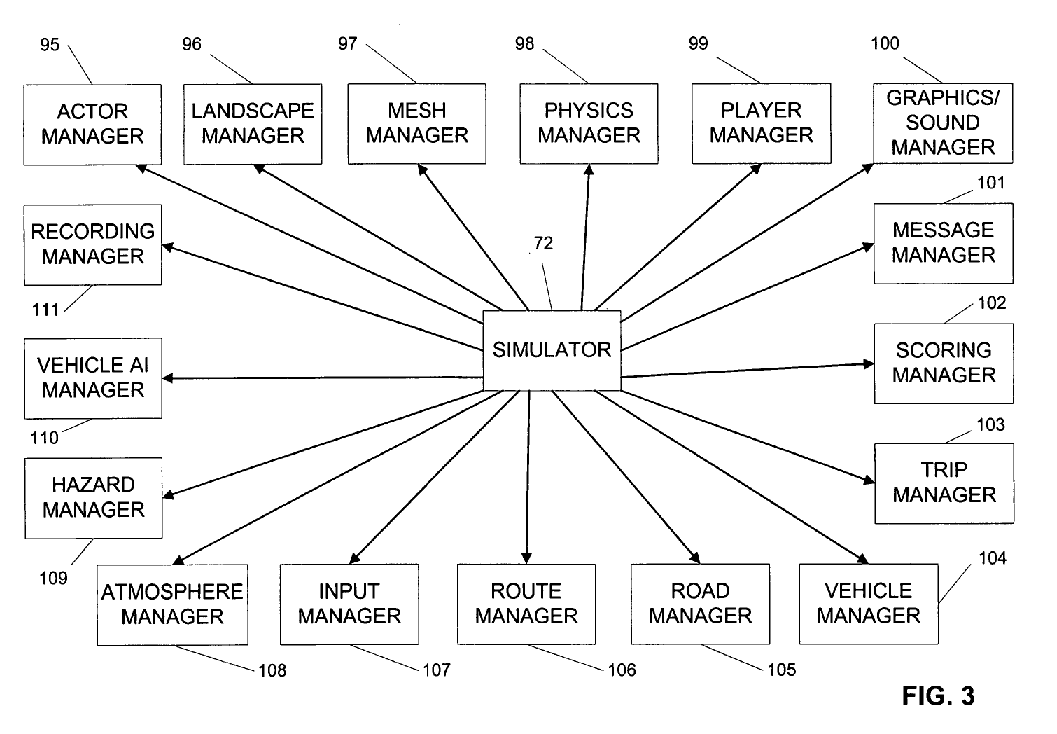

FIG. 3 illustrates exemplary managing components of the driving simulator application architecture illustrated in FIG. 2. The managing components illustrated in FIG. 3 may be part of the manager module 80 illustrated in FIG. 2, and may be available to the simulator module 72. The simulator module 72 may include an actor manager 95, a landscape manager 96, a mesh manager 97, a physics manager 98, a player manager 99, a graphics and sound manager 100, a message manager 101, a scoring manager 102, a trip manager 103, a vehicle manager 104, a road manager 105, a route manager 106, an input manager 107, a atmosphere manager 108, a hazard manager 109, a vehicle artificial intelligence (“AI”) manager 110, and a recording manager 111. In some embodiments, the actor manager 95 may be configured to manage the pedestrians simulated by the driving simulator 50. The landscape manager 96 is configured to manage the background or terrain displayed to the user 58 such as mountains, grass fields, cityscape, or the like. The mesh manager 97 may be configured to mange the computerized wire frames of the simulated objects such as the vehicles; roads, and hazards. The graphics and sound manager 100 may be configured to provide and manage an interface to the graphics and sound rendering module 84. In particular, the physics manager 98 may be configured to interface with a physics engine, which may be a component of the graphics and sound rendering module 84. The player manager 79 is configured to mange the recording and replaying performed by the player module 76.

During the operation of the driving simulator 50, messages may be generated concerning the simulated driving environment and the operation of the simulated vehicle. For example, a message may be generated as the simulated vehicle travels down a road, alerting scripted hazards, simulated intelligent vehicles, or the like to the position or location of the simulated vehicle. A message may also be generated if intersections are clear of incoming traffic, if the simulated vehicle turns a corner, if the driver of the simulated vehicle checks a mirror or applies the brakes, and the like. The message manager 101 may be configured to manage messages generated during the operation of the driving simulator 50. The message manager 101 may route messages to or alert components or modules that may use the data contained in the message, when messages are generated.

In some embodiments, each operation of the driving simulator 50 is scored using a scoring algorithm to generate an overall indicator of the performance of the user 58 operating the simulator 50. The scoring manager 102 may be configured to compute a score for the performance of the user 58. For example, after the user 58 drives a simulated vehicle through a simulated trip, the user's performance may be scored. Scoring the performance may include reviewing any accidents or infractions the user 58 had, the time taken to drive the trip, the number of times the user 58 checked their mirrors, or the like. In some embodiments, infractions are assigned a point or penalty value and the user's 58 score for driving a trip is the accumulation of points associated with the user's 58 infractions during the trip. Positive driving operations may also be given point values that cancel out points accumulated for infractions.

The route manager 106 may be configured to manage the current route being simulated by the driving simulator 50. The route manager 106 may monitor the start and end of the route, the number of miles making up the route, the current position in the route, and the like. The trip manager 103 may be configured to manage the current trip within the current route being simulated by the driving simulator 50. In particular, the road manager 105 may manage the roads making up the current trip and the vehicle manager 104 configured to manage the simulated vehicle traveling along the roads making up the current trip.

The input manager 107 may be configured to manage the input devices operated by the user 58 to control the simulated vehicle or, more generally, the driving simulator 50. The input devices managed by the input manager 107 may include but are not limited to, the steering wheel input device 54, the pedal input device 56, a keyboard, a mouse, a joystick, or the like.

In some embodiments, the atmosphere manager 108 is configured to manage the lighting and effects applied to a particular landscape or terrain to adjust the time of day, season, or weather of the displayed landscape. For example, the atmosphere manager 108 may add fog, rain, leaves, sunlight glare, or the like to a landscape.

The hazard manager 109 may be configured to manage the hazards scripted into the currently displayed trip. The hazard manager 109 may be responsible for activating a hazard when appropriate and adjusting its speed, position, or the like based on the parameters set by the user 58.

The vehicle AI manager 100 may be configured to manage the simulated AI, or intelligent, vehicles. The vehicle AI manager may control when simulated AI vehicles are displayed to the user 58, removed from the display 60, re-spawned at a new location within the currently displayed trip, accelerated or decelerated, stopped for traffic or for a traffic signal, and the like. The vehicle AI manager 100 will be explained in further detail below.

The recording manager 111 may be configured to record statistics of the operation of the driving simulator 50, such as the simulated vehicle's speed, the application of brakes, the checking of mirrors, times during the trip when the simulated vehicle was off the road, and times of accidents and infractions. In some embodiments, the recording manager 111 may also record the frames displayed to the user 58 during the operation of the driving simulator so that the player module 76 may replay the operation to the user 58. The data recorded by the recording may be stored in the history database 86.

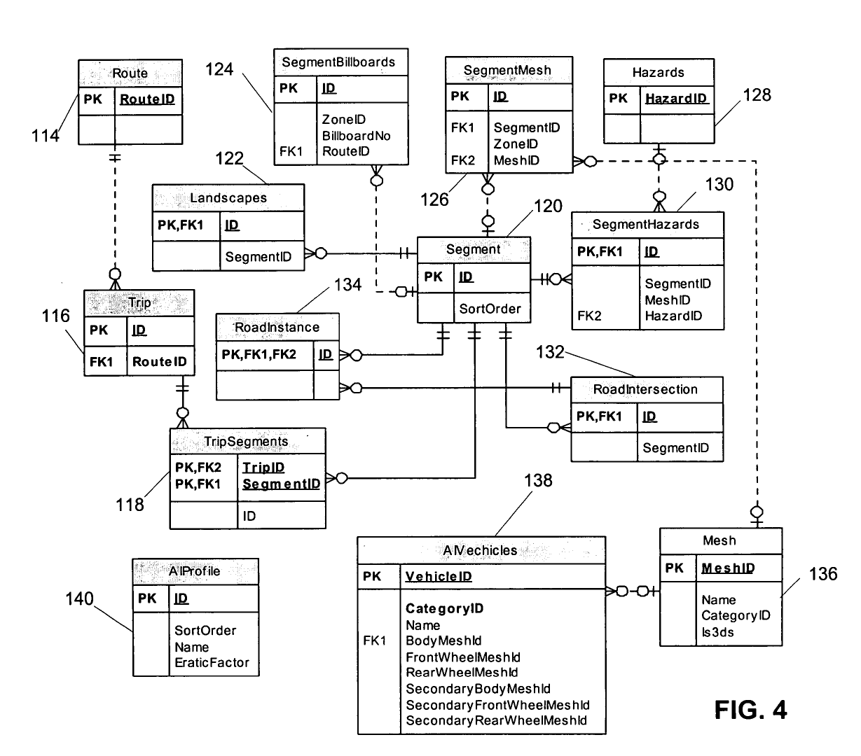

FIG. 4 is an entity/relationship diagram illustrating the interoperability of the application objects or entities of the driving simulator 50. The entities illustrated in FIG. 4 may be stored in one of the databases of the driving simulator 50, such as the trip database 90 or media database 92. The entities includes a Route entity 114, a Trip entity 116, a TripSegments entity 118, a Segment entity 120, a Landscapes entity 122, a SegmentBillboards entity 124, a SegmentMesh entity 126, a Hazards entity 128, a Segment Hazards entity 130, a RoadIntersection entity 132, a RoadInstance entity 134, a Mesh entity 136, an AIVehicles entity 138, and an AIProfile entity 140. The Route entity 114 represents a geographical location. The Route entity 114 may consists of a number of individual Trip entities 98 that travel through the Route entity 114. As indicated by the symbols of the entity/relationship diagram, the Route entity 114 has many Trip entities 116, and each Trip entity 116 is associated with one and only one Route entity 114.

Each Trip entity 116 may be further broken down to contain one or more TripSegments entities 118. Each TripSegments entity 118 contains one Segment entity 120. In some embodiments, the Trip entities 116 are constructed from a number of TripSegments entities 118, or ultimately, a number of Segment entities 120, so that Segment entities 120 can be reused and quickly replicated to create new trips. Each Segment entity 120 may be associated with a Landscapes entity 122, a SegmentBillboards entity 124, a Segment Mesh entity 126, a SegmentHazards entity 130, a RoadIntersection entity 132, and a RoadInstance entity 134.

The Landscapes entity 122 specifies the background scenery displayed with the trip segment. For example, the Landscape entity 122 may specify a mountain background, city background, country background, or the like. The SegmentBillboards entity 124 may specify the objects to be placed along the trip segment such as trees, billboards, buildings, or the like. The SegmentMesh entity 126 also specifies a mesh, or computerized metal frame structure on which the graphical representation of the Segment entity 120, including the landscape, trees, billboards, and the like are placed to create a three-dimensional image. The SegmentHazards entity 130 may include a Hazards entity 128 that specifies the type of hazards present in the Segment entity 120. The SegmentHazards entity 130 provides further information regarding the Hazard entity 128, or type of hazard, such as location or placement of the hazard within the segment. The RoadInstance entity 134 specifies a particular road making up the trip segment. The RoadInstance entities 134 referred or associated with the Segment entity 120 may specify the main roads to be maneuvered by the user 58. Each Segment entity 120 may specify an order that the associated RoadInstance entities 134 should be joined. Each RoadInstance entity 134 contains a RoadIntersection entity 132 that specifies an intersection or connecting point between RoadInstance entities 134. Each Segment entity 120 may include a number of RoadInstance entities 134.

The SegmentMesh entity 126 may contain or reference the Mesh entity 136 that specifies a base type of shape of mesh to use for the Segment entity 120. Each AIvehicles entity 138 may also reference a base Mesh entity 136.

The AIProfile entity 140 specifies an AI profile. Each AI profile may be used by the driving simulator 50 to set or configure the operation or control of an intelligent simulated object such as simulated intelligent vehicles. For example, an AI profile may set an aggression level of a driver of a simulated intelligent vehicle to aggressive, timid, normal, or the like.

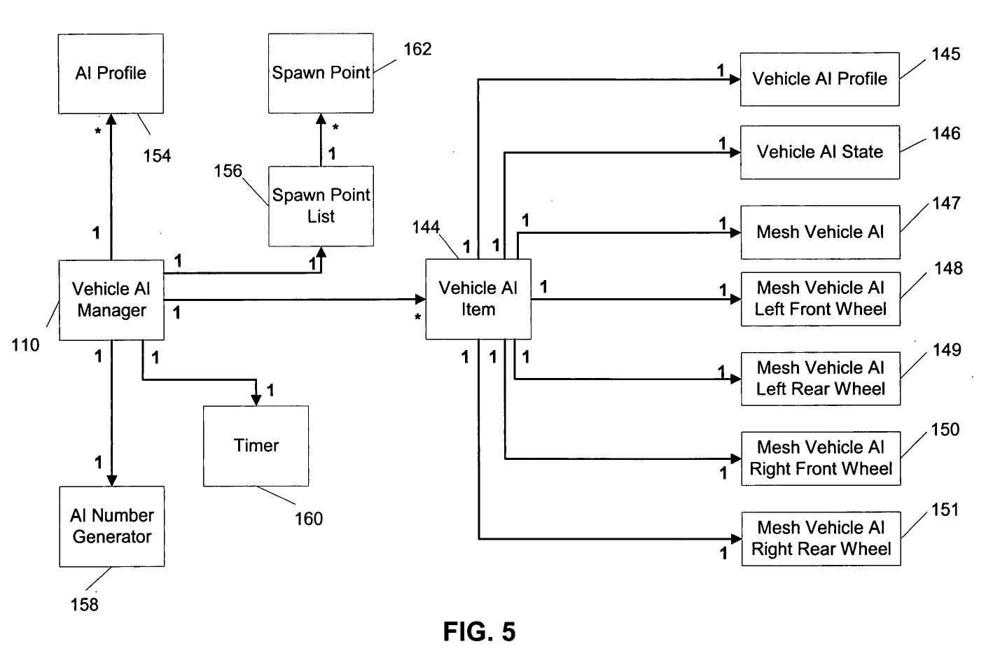

FIG. 5 is a class diagram illustrating exemplary components managed by the vehicle AI manager 110 illustrated in FIG. 3. As previously described, the vehicle AI manager 110 may be configured to control one or more simulated intelligent vehicles operated by the driving simulator 50. The vehicles are intelligent in the sense that they are controlled by the instructions executed by the processor 62 rather than a human such as the user 58. The vehicles controlled by the vehicle AI manager 110 are programmed to act as normal vehicles. For example, the intelligent vehicles travel along a road or trip and may not crash into other intelligent vehicles or the vehicle controlled by the user 58 or travel off the road. The vehicle AI manager 110 contains one or more vehicle AI items 144. In some embodiments, each vehicle AI item 144 represents a single simulated intelligent vehicle. Each vehicle AI item 144 contains a vehicle AI profile 145, a vehicle AI state 146, a mesh-vehicle AI 147, a mesh-vehicle AI left front wheel 148, a mesh-vehicle AI left rear wheel 149, a mesh-vehicle AI right front wheel 150, and a mesh-vehicle AI right rear wheel 152. The vehicle AI profile 145 contains information pertaining to the type of simulated intelligent vehicle. The type of simulated intelligent vehicle may specify the make or model of the vehicle, the color, special features, or the like. The vehicle AI profile 145 may also contain an aggression level for the simulated intelligent driver of the simulated intelligent vehicle. The aggression level may be chosen from a number of levels or categories including normal, aggressive, overly aggressive, timid, and overly timid. The aggression level is used to simulate intelligent vehicles that appear to be driven by a number of driver types. A simulated intelligent vehicle with an overly aggressive aggression level may drive faster, change lanes more often, follow closer, brake more suddenly, or the like than a simulated intelligent vehicle with a timid aggression level.

In some embodiments, the vehicle AI state 146 of each vehicle AI item 144 specifies the present state or condition of the simulated intelligent vehicle. For example, the vehicle AI state 146 may indicate that a simulated intelligent vehicle is paused and waiting for traffic or a traffic signal, is traveling at a certain speed or has a particular acceleration or deceleration, or is a given distance from the simulated vehicle being operated by the user 58. This data may be used by the vehicle AI manager 110 to operate the simulated intelligent vehicle as described below.

The mesh-vehicle AI 147, mesh-vehicle AI left front wheel 148, mesh-vehicle AI left rear wheel 149, mesh-vehicle AI right front wheel right 150, and mesh-vehicle AI right rear wheel 151 may be configured to graphically create the frame of the simulated intelligent vehicle. As previously indicated, a mesh represents a computerized frame structure on which a graphical overlay is applied and is configured to recognize collision. Each mesh-vehicle AI may be configured to provide functionality for a particular component of the simulated intelligent vehicle such as the body and wheels. It should be understood that a single mesh may be specified for the entire simulated intelligent vehicle.

The vehicle AI manager 110 also contains one or more AI profiles 154, a spawn point list 156, an AI number generator 158, and a timer 160. Each AI profile 154 contains settings that the vehicle AI manager 110 may use to generate and control a vehicle AI item 144. For example, an AI profile 154 may contain a percentage specifying the number of simulated intelligent vehicles to generate, the types of simulated intelligent vehicles to generate, atmosphere settings or trip parameters that influence the operation of the simulated intelligent vehicles (i.e., if the time of day of the simulated driving environment is set to night, the simulated intelligent vehicles should have their headlights on), aggression level percentages specifying the percent of simulated intelligent vehicles that should have normal profiles, aggressive profile, etc., or the like. The vehicle AI manager 110 may use the data included in the AI profile 154 when generating intelligent vehicles. For example, if the AI profile 154 specifies that 80% of the simulated intelligent vehicles should have aggressive profiles and 15 simulated intelligent vehicles should be generated in total, the vehicle AI manager 110 will create 12 simulated intelligent vehicles having an aggressive profile.

The spawn point list 156 contains a number of spawn points 162 or locations in a simulated driving environment where a simulated intelligent vehicle will begin operating. Spawn points 162 may be generated randomly using the AI number generator 158. The vehicle AI manager 110 may generate a number of spawn points 162, store them in the spawn point list 156, and use each individual spawn point 162 in turn to place or spawn a simulated intelligent vehicle. After the simulated intelligent vehicle has been spawned, the vehicle AI manager 110 may use the timer 160 and the data contained in the vehicle AI state 146 to determine how far a simulated intelligent vehicle has traveled from its spawn point based on its current speed. The distance traveled by the simulated intelligent vehicle may be utilized by the vehicle AI manager 110 to determine the distance from the simulated vehicle operated by the user 58. Depending on the distance from the vehicle operated by the user 58, the vehicle AI manager 110 may decide that the simulated intelligent vehicle is far enough away from the vehicle operated by the user 58 where the simulated intelligent vehicle will no longer be seen by or capable of interacting with the simulated vehicle operated by the user 58. In this situation, the vehicle AI manager 110 may remove the simulated intelligent vehicle and provide it with a new spawn point 162 from the spawn point list 156.

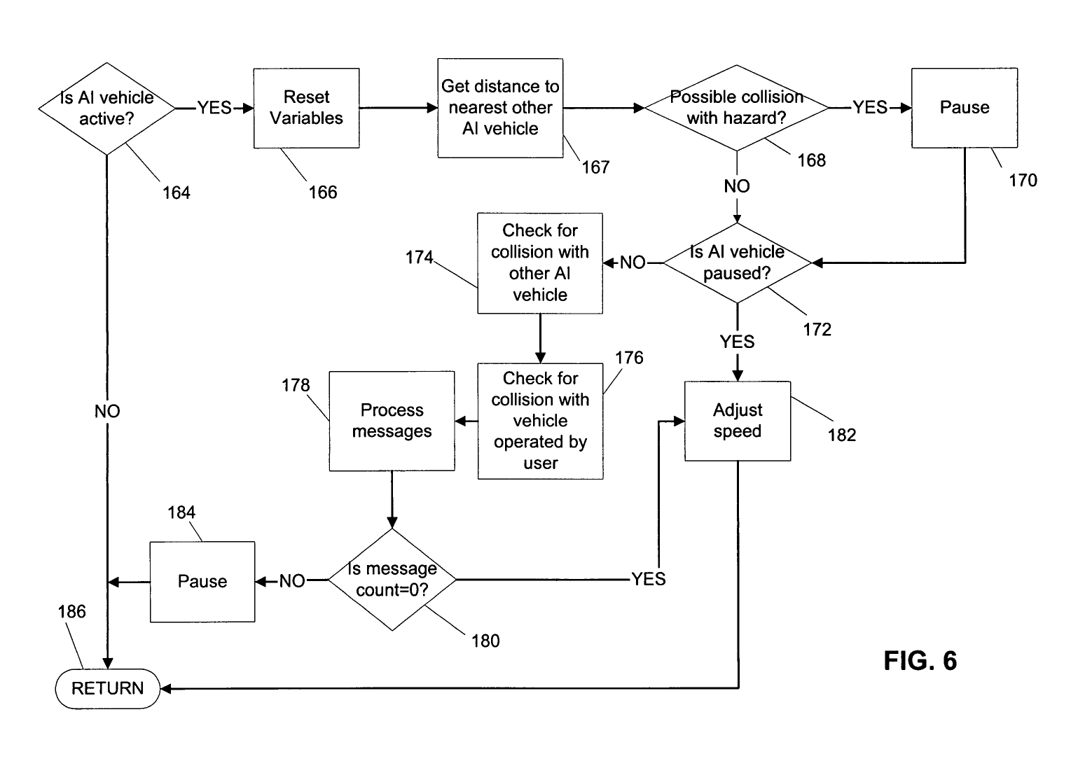

FIG. 6 is a flow chart illustrating an exemplary process that the vehicle AI manager 110, or similar managing component, may use to control the simulated intelligent vehicles. The vehicle AI manager 110 may perform the process depicted in FIG. 6 for each simulated intelligent vehicle it controls. The vehicle AI manager 110 beings the process by determining if an individual simulated intelligent vehicle is active (block 164). If the simulated intelligent vehicle is not active than the vehicle AI manager 110 does not need to provide operational data to the simulated intelligent vehicle and can return to a main program (block 165) to perform additional management functionality such as selecting another simulated intelligent vehicle and restarting the process at block 164.

If the simulated intelligent vehicle is active, the vehicle AI manager 110 resets the variables associated with the simulated intelligent vehicle (block 166). The variables may include the state, speed, location, or the like of the simulated intelligent vehicle. After resting the variables, the vehicle AI manager 10 determines the distance from the simulated intelligent vehicle to the nearest other simulated intelligent vehicle (block 167).

At block 168, the vehicle AI manager 110 determines whether the simulated intelligent vehicle may collide with a hazard such as an animal or object in the road, a scripted vehicle pulling out or running a stop sign, or the like. If a collision is possible, the simulated intelligent vehicle is paused to avoid the collision (block 170). In some embodiments, the simulated intelligent vehicle is paused for three seconds and then unpaused automatically. In other embodiments, the simulated intelligent vehicle may be paused until it is specifically unpaused once the collision is avoided.

After pausing the simulated intelligent vehicle to avoid a possible collision or if a collision is not possible, the vehicle AI manager 110 determines if the simulated intelligent vehicle is paused (step 172). If the simulated intelligent vehicle is not paused, the vehicle AI manger 90 determines whether a collision is possible with another simulated intelligent vehicle by comparing data regarding the current simulated intelligent vehicle and other active simulated intelligent vehicles managed by the vehicle AI manager 110 (block 174). The vehicle AI manager 110 may also check to see if the current simulated intelligent vehicle may collide with the simulated vehicle operated by the user 58 (block 76). In some embodiments, checking for possible collisions may entail generating a message if a collision is not possible. The lack of a message indicates that a collision is possible. At block 178, after checking for possible collisions, the vehicle AI manager 110 may process messages generated during the checking process. At block 180, the vehicle AI manager 110 determines the number of messages that were generated during the checking process. If no messages were generated, the speed of the current simulated intelligent vehicle is adjusted to decrease the likelihood of the possible collision (block 182). Adjusting the speed may include increasing or decreasing the speed. After adjusting the speed of the simulated intelligent vehicle, the vehicle AI manager 110 returns to check and possibly modify the operation of another simulated intelligent vehicle.

If, however, at least one message was generated, the vehicle AI manager 110 pauses the simulated intelligent vehicle at block 184 and returns to check another simulated intelligent vehicle (block 186). As previously indicated, the paused simulated intelligent vehicle may be configured to unpause itself after a given time period, such as three seconds.

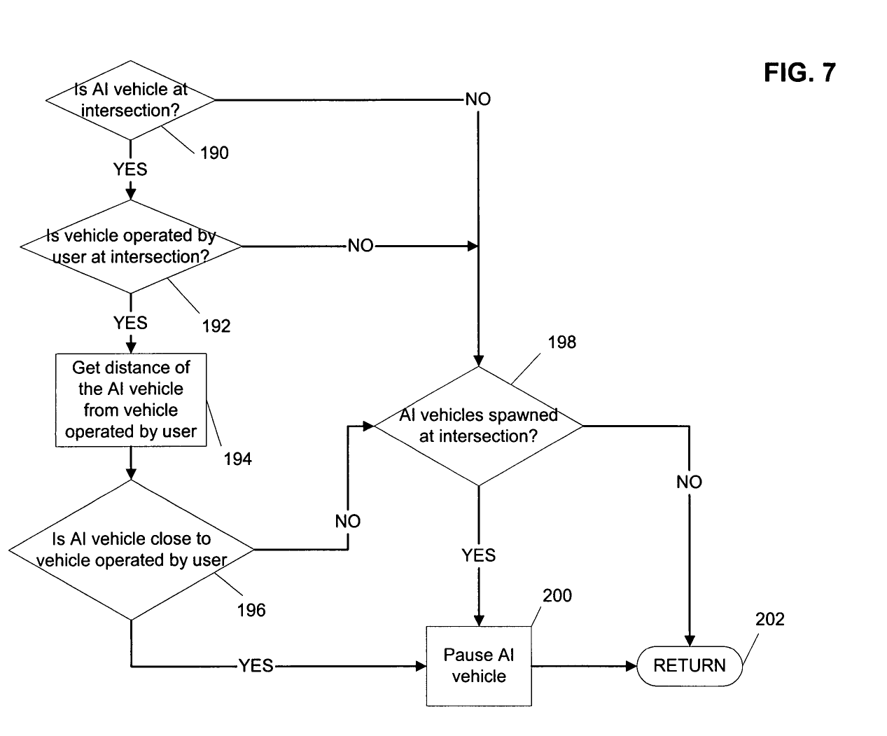

FIG. 7 is a flow chart illustrating another exemplary process utilized by the vehicle AI manager 110, or similar managing component, to operate one or more simulated intelligent vehicles. The vehicle AI manager 110 uses the process illustrated in FIG. 7 when a simulated intelligent vehicle comes to an intersection in the simulated driving environment. The vehicle AI manager 110 determines whether a simulated intelligent vehicle is at an intersection (block 190). If a simulated intelligent vehicle is at an intersection, the vehicle AI manager 110 determines if the simulated vehicle operated by the user 58 is at or going through the same intersection (block 192). If the simulated vehicle operated by the user 58 is at or going through the same intersection, the vehicle AI manager 110 determines the distance from the simulated intelligent vehicle to the simulated vehicle operated by the user 58 (block 194) and determines if the simulated intelligent vehicle is close or possibly colliding with the simulated vehicle operated by the user 58 (block 196).

If the simulated intelligent vehicle is not at an intersection, not at an intersection that the simulated vehicle operated by the user 58 is at, nor possibly colliding with the simulated vehicle operated by the user 58, the vehicle AI manager 110 determines if any simulated intelligent vehicles spawned at the intersection or elsewhere (block 198). If simulated intelligent vehicles have been spawned, the current simulated intelligent vehicle is paused (block 200). As previously described, a simulated intelligent vehicle may remain paused for a given time duration. Alternatively, a vehicle may be unpaused once it is determined that a safe condition exists (i.e., no possible collisions exist).

If no simulated vehicles have been spawned, the vehicle AI manager 110 may return to check another simulated intelligent vehicle (block 202) and the current simulated intelligent vehicle may continue to operate as configured (i.e., travel through the intersection, turn left, etc.).

The vehicle AI manager 110 may be configured to execute the above processes on a regular basis, such as every frame or every few frames displayed to the user 58.

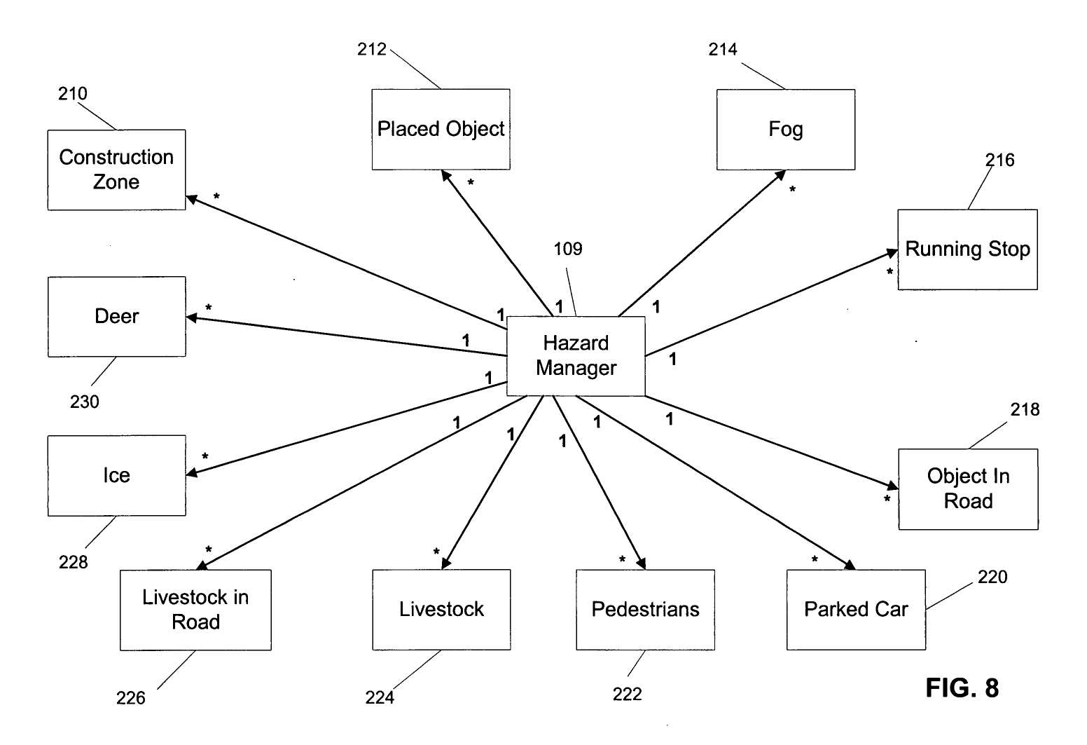

Another manager illustrated in FIG. 4, was the hazard manager 109. Similar to the vehicle AI manager 110, the hazard manager 109 may be configured to control hazards placed in the simulated driving environment. FIG. 8 illustrates the hazard manager 109 and exemplary types of hazards that it may manage. For a particular simulated driving environment, the hazard manager 109 may manage a variety of difference types of hazards and may control a number of hazards of a particular type as indicated in FIG. 8. In some embodiments, the types of hazards available for placement into a simulated driving environment may include, but are not limited to, a construction zone hazard 210, a placed object hazard 212, a fog hazard 214, a running stop hazard 216, an object-in-road hazard 218, a parked car hazard 220, a pedestrian hazard 222, a livestock hazard 224, a livestock-in-road hazard 226, an ice hazard 228, and a deer hazard 230. The placed object hazard 212 may represent a superset comprising all hazards that are specifically placed within a simulated driving environment. For example, a deer hazard 230 may also be a placed object hazard 212 if the deer hazard 230 is scripted with particular placement conditions such as location, time, range of locations, or range of times. The livestock hazard 224 may also be a superset that encompasses the livestock-in-road hazards 226. Livestock-in-road hazards 226 may also be livestock hazards 224 that are positioned to be on the road rather than other locations such as the side of the road. The names of the remaining hazards are indicative of the hazards they represent and therefor will not be explained in detail herein. Each hazard may include data specifying where the hazard is scripted or planned to occur, how likely the hazard is to occur, the type of object to be placed in or along side the road, or the like. When rendering frames to be displayed to the user 58, the hazard manager 109 my dictate when and what hazards are graphically included in each frame depending on the operation of the simulated vehicle by the user 58.

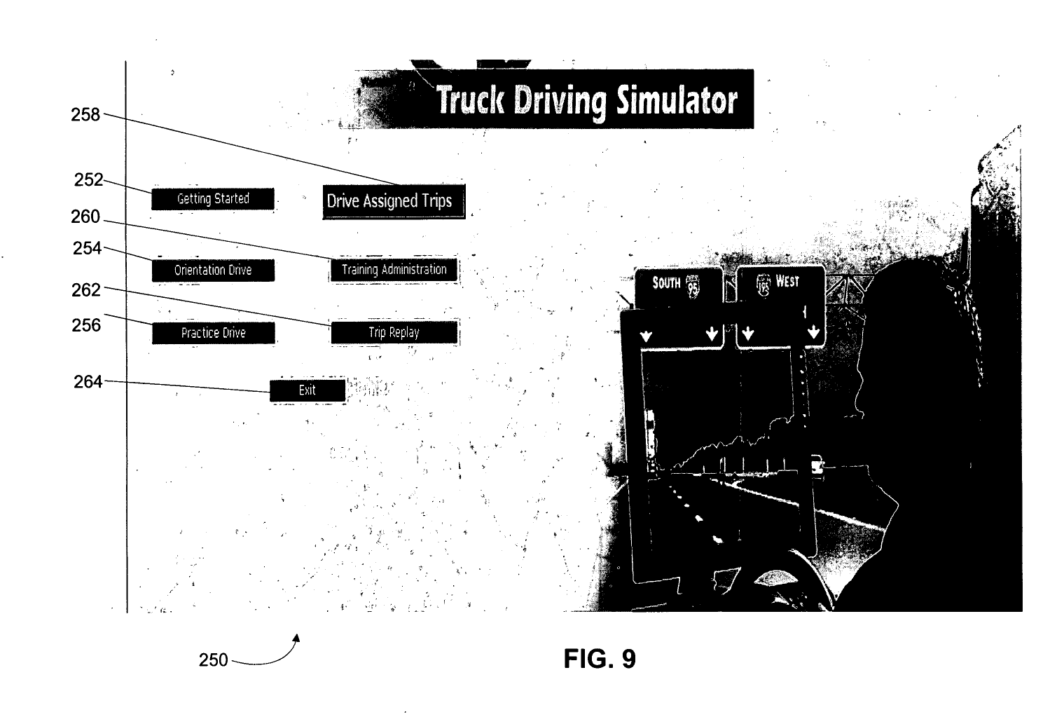

FIGS. 9-19 illustrate exemplary screen shots that may be displayed to the user 58 to configure and set up a simulated driving environment. FIG. 9 illustrates an exemplary main menu screen 250. The main menu screen 250 includes a getting started button 252, an orientation drive button 254, a practice drive button 256, a drive assigned trips button 258, a training administration button 260, a trip replay button 262, and an exit button 264. The getting started button 252 may provide informational data and directions to the user 58 on how to setup and operate the driving simulator 50. The orientation drive button 254 may provide a training simulated driving environment to the user 58 such that helpful hints or suggestions are relayed to the user 58 during operation. Selecting the practice drive button 256 may allow the user 58 to operate a brief practice simulated driving environment configured to allow the user 58 to practice general operations of the driving simulator 50 such as speeding up, slowing down, stopping, turning, and the like. The drive assigned trips button 258 may be used by the user 58 to view and select a simulated driving environment to perform based on assignments made by the user 58 or a trainer or administrator using a screen accessed through the training administration button 260. The trip replay button 262 allows the user to replay a previously performed trip. The exit button 264 exits the driving simulator 50.

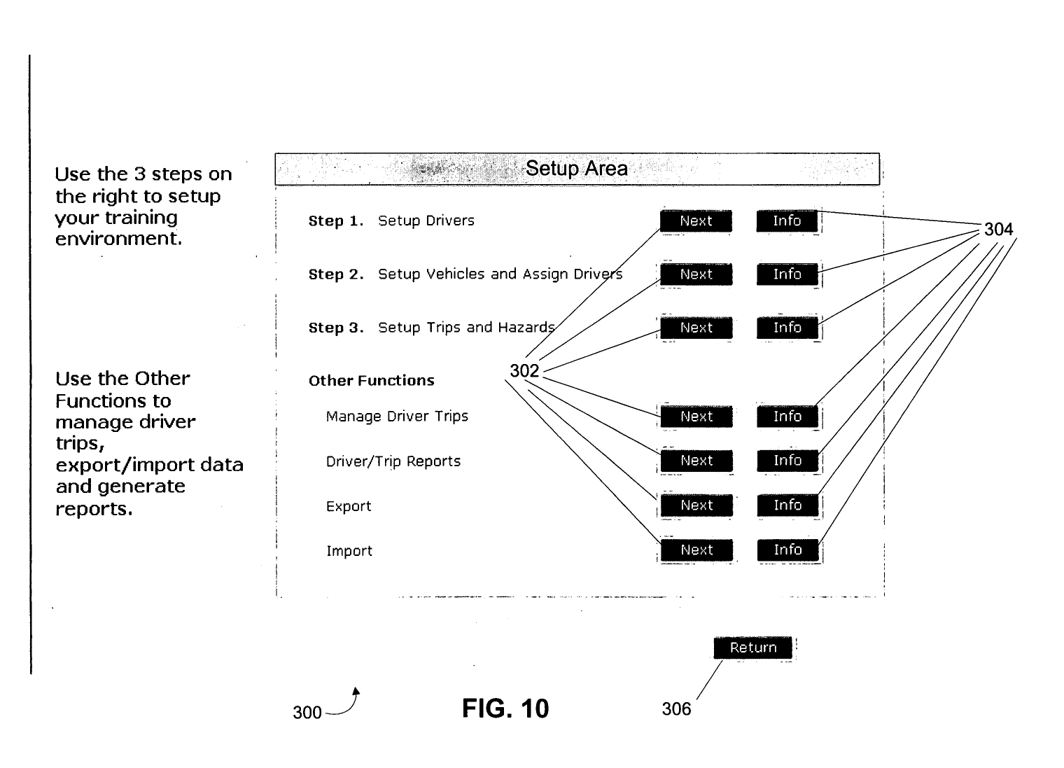

FIG. 10 illustrates an exemplary preliminary set-up screen 300. The preliminary setup screen 300 provides a number of steps and functions available to the user 58 to configure and manage the operation of a driving simulator 50. The preliminary setup screen 300 may be accessed by selecting the training administration button 260 displayed on the main menu screen 250. Each step or function listed on the preliminary setup screen 300 includes an associated next button 302 and info button 304. Choosing a next button 302 may take the user 58 to a screen associated with the step or function associated with the chosen next button 302. Choosing a help button 304 may provide additional information specifying details of the step or function associated with the help button 304. The preliminary setup screen 304 may further include a return button 306 that, when selected, redisplays a previously displayed screen, such as the main menu screen 250 illustrated in FIG. 9.

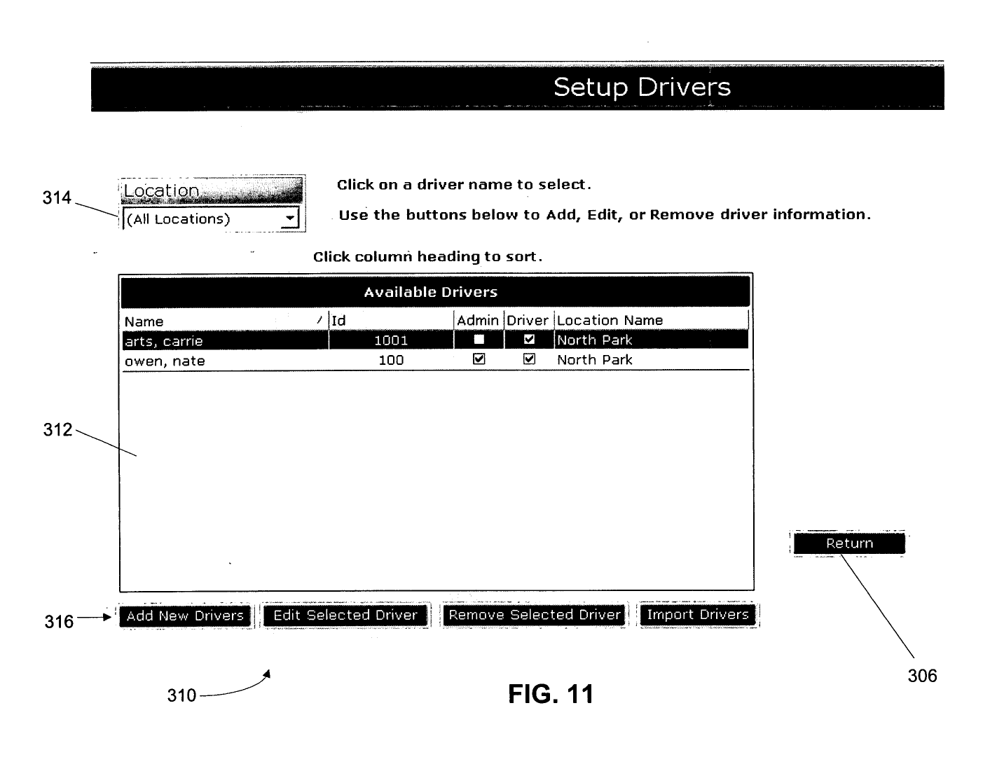

FIG. 11 illustrates an exemplary driver setup screen 310. The driver setup screen 310 may include a list of available drivers or users 312 of the driving simulator 50, a location drop-down tool 314, and a control section 316. The list of available users 312 may include information such as a user's name, identification or employee number, a specification whether a user is an administrator or trainer, and the location of a user. In some embodiments, the list of available users 312 can be sorted by a particular information field by clicking on the column heading. The list of available users 312 may also be filtered to include only users with a certain location using the location drop-down tool 314. The location may specify a branch of a company that the user works at or a particular terminal assigned to the user. The control section 316 may contain buttons that allow the list of available users to be modified. The screen 310 may also include the return button 306.

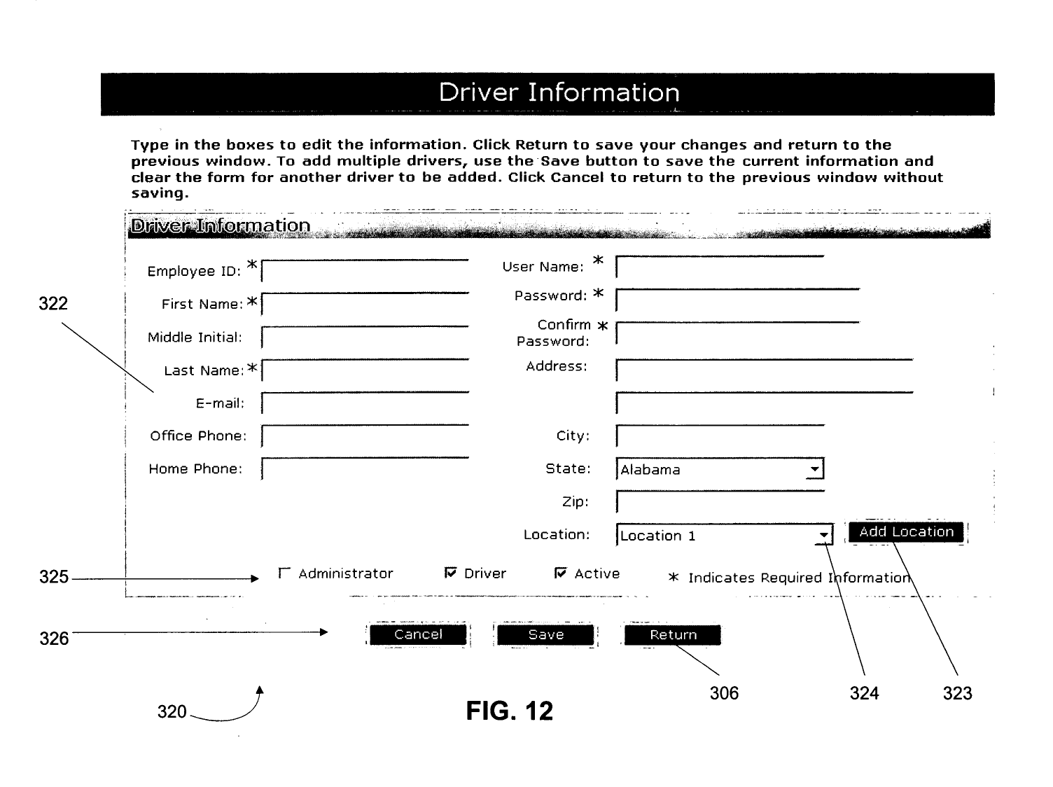

FIG. 12 illustrates an exemplary driver addition screen 320. The driver addition screen 320 may be accessed by clicking on a button in the control section 316 of the driver setup screen 310 that indicates a driver needs to be added to the list of available users 312. The driver addition screen 320 includes a driver information form section 322, an add location button 323, a location drop-down tool 324, a type selection section 325, and a commit section 326 containing the return button 306. The driver information form section 322 where the user 58 can type information regarding a new driver or user such as name, identification number, phone number, user name and password, addresses, location, etc. When specifying the location of a new driver, the user 58 may utilize the add location button 323 to specify a new location not listed in the location drop-down tool 324. The user 58 may also specify the type of the added driver in the type selection area 325. The user 38 may designate an added driver as an administrator, a driver, and an active user. Other types of drivers may also be available. After entering the information for a new driver, the user 58 may save or cancel the added driver using the buttons in the commit section 326 of the driver addition screen 320.

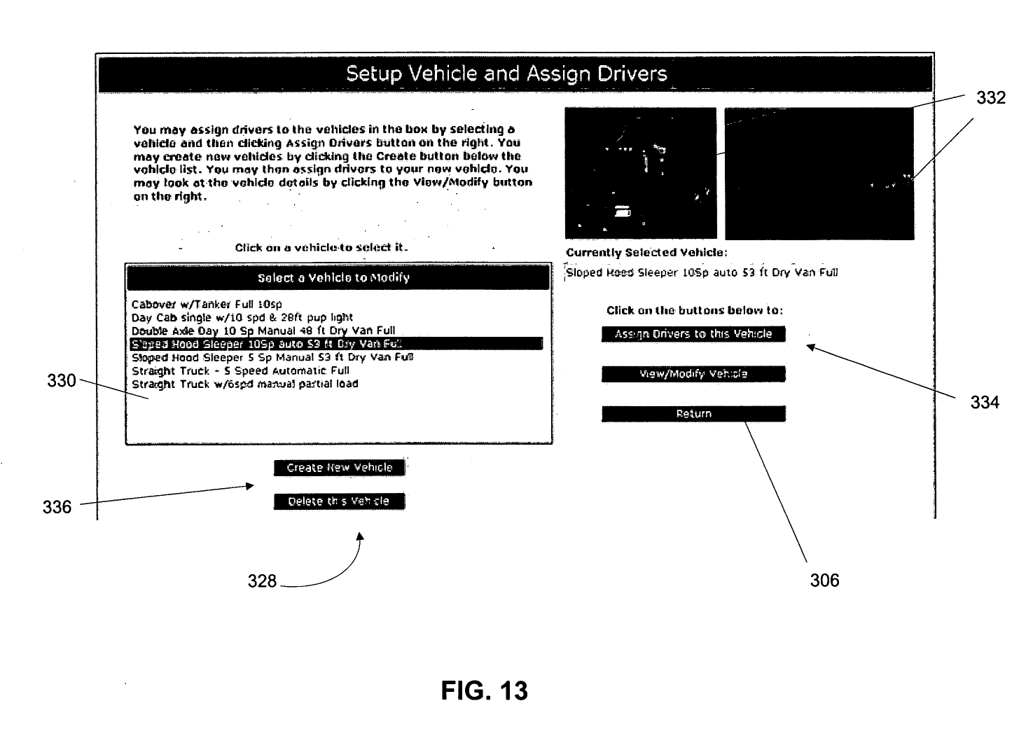

After the user 58 has setup a driver, the user 58 can assign a vehicle to a driver from the vehicle setup screen 328 illustrated in FIG. 13. The vehicle setup screen 328 contains a list of available vehicles 330, a preview image 332, a control section 334 including the return button 306, and a list modification section 336. In some embodiments, clicking on or highlighting one of the vehicles listed in the list of available vehicles 330 causes the preview image 332 to illustrate the selected vehicle in the top right corner of the vehicle setup screen 328. After selecting a vehicle from the list of available vehicles 330, the user 58 may use the control section 334 of the vehicle setup screen 328 to assign a driver to the selected vehicle, view and/or modify characteristics of the selected vehicles, or the like. The user 58 may also use the list modification section 336 of the vehicle setup screen 328 to add or delete vehicles to the list of available vehicles 330.

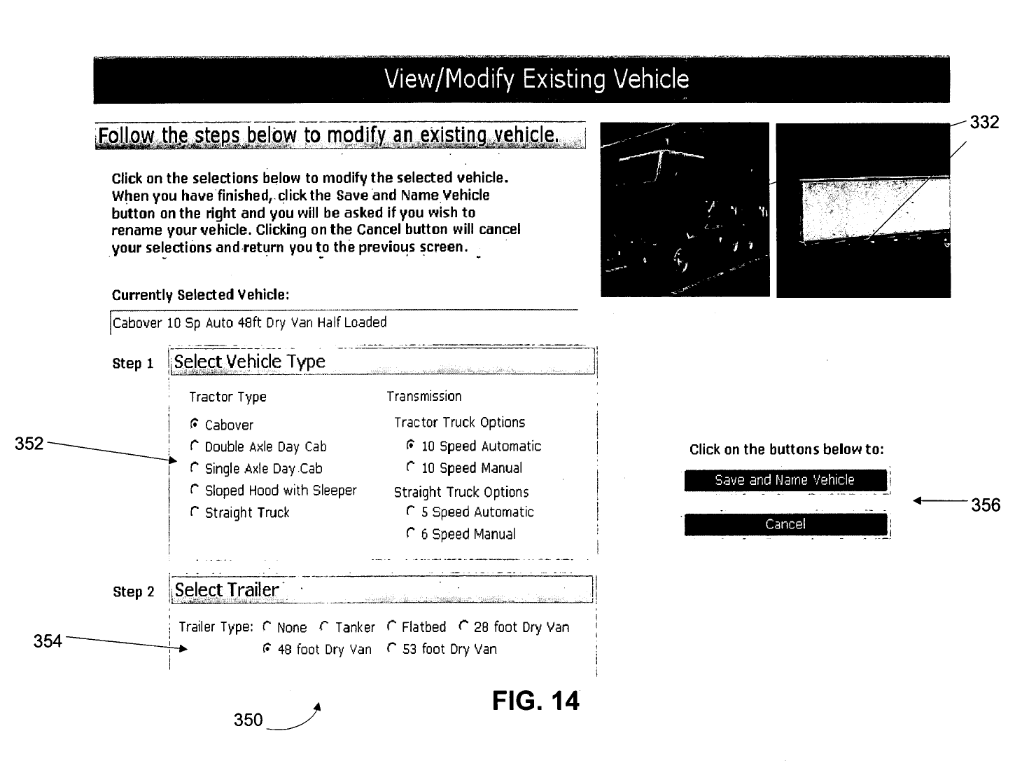

FIG. 14 illustrates a vehicle setting screen 350 that may be used to view or modify existing vehicles or add new vehicles. The vehicle setting screen 350 includes a vehicle type selection form 352, a trailer type selection form 354, the preview image 332, and a control section 356. In some embodiments, the user 58 uses the vehicle type selection form 352 to specify a tractor type, transmission type, and other truck options. The user 58 may also use the trailer type selection form 354 to choose a trailer type, weight, or the like for the trailer pulled by the selected tractor. Similar to FIG. 13, the preview image 332 may be displayed in the upper right-hand corner of the vehicle setting screen 350 illustrating a visual representation of the created vehicle. The control section 356 allows the user 58 to save a modified or added vehicle or cancel any changes or additions made and return to a previous screen.

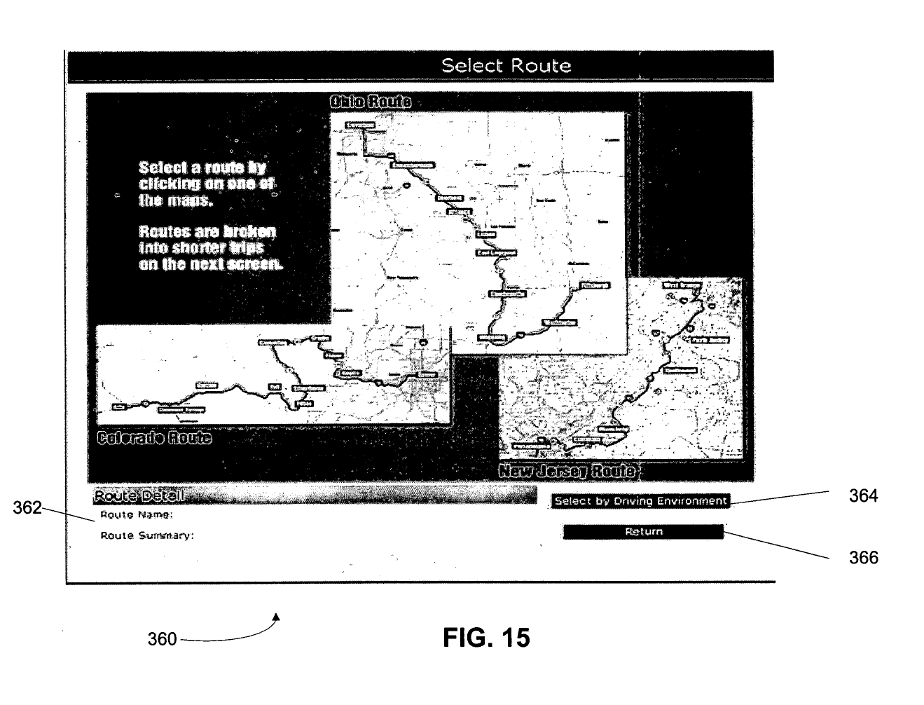

In some embodiments, after the user 58 has setup a driver and assigned a driver to a vehicle, the user 58 selects a route. FIG. 15 illustrates a route selection screen 360. The route selection screen 360 contains a route detail section 362, a select by driving environment button 364, and the return button 306. The exemplary route selection screen 360 contains three possible routes each representing a known geographical location. Clicking or highlighting one of the routes may cause a summary or synopsis of the route to appear in the route detail section 362.

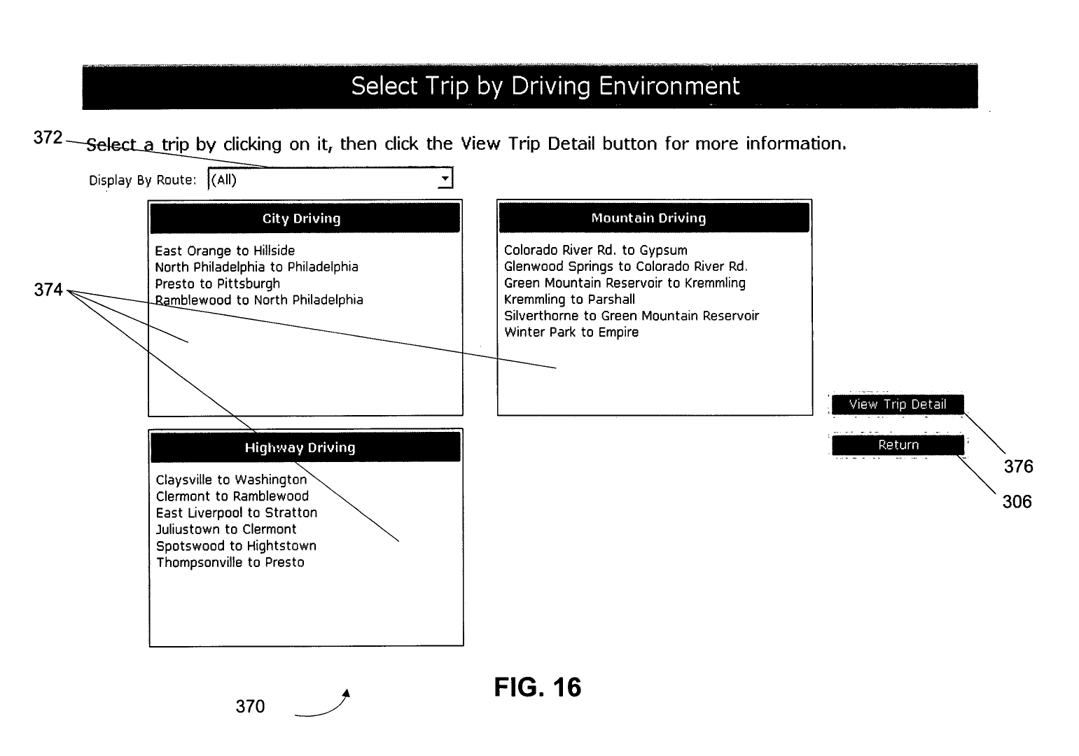

Rather than directly selecting a route, the user 58 may also choose to select a route by viewing the different driving environments available. The user 58 may click the select by driving environment button 364 on the route selection screen 360 to view each of the routes categorized by driving environment such as whether the route includes city driving, country driving, mountain driving, night driving, extreme weather driving, or the like. Each route, or geographical location, may include a number of individual trips that a driver can take through the route. The trips taken together comprise the route. FIG. 16 illustrates a driving environment categorization screen 370 that lists the trips within categories. The driving environment categorization screen 370 contains a route drop-down tool 372, one or more category lists 374, a view trip detail button 376, and the return button 306. The user 58 can select a route, or all routes, from the route selection drop-down tool 372 and the trips comprising the selected route or routes are presented one of the category lists 374 that best describes the driving environment presented in the trip. Three category lists 374 are shown, but additional category lists may be added. Each trip may be listed in one or many category lists 374. In some embodiments, trips are not listed if category lists 374 do not exist that properly describes a trip's driving environment. Clicking or highlighting a trip and clicking the view trip detail button 376 displays additional information regarding the selected trip, such as mileage, time of day, weather, type of streets (i.e., 2-lane highway, dirt road, or the like), construction, or the like.

After the user 58 has selected a route from the route selection screen 360 or selected a trip within a route from the driving environment categorization screen 370, the user 58 may specify additional settings and parameters on a trip setup screen 380. The trip setup screen contains a trip selection section 382, a trip information section 383, a hazard selection section 384, a hazard detail section 386, a likelihood of occurrence selection tool 388, a risk factor selection tool 390, an atmosphere selection section 392, a profile selection section 394, a commit button 396, a cancel button 398, and the return button 306. The trip selection section 382 allows the user 58 to select a trip within a route. If the user 58 previously selected a trip from the driving environment categorization screen 370, the trip selection section 382 may already indicate the selection made by the user 58. To the right of the trip selection section 382, in the trip information section 383, a summary or detailed description of the selected trip may be displayed. The information presented in the trip information section 383 may change as the user 58 sets other parameters of the trip as described below.

After the user 58 has selected an individual trip, the user 58 can configure the hazards presented along the trip by using the hazard setup section 384. The hazard setup section 384 includes a listing of available hazards and allows the user 58 to turn on or off hazards by clicking a check-box tool next to each listed hazard. In some embodiments, each hazard is programmed into a trip to occur at a particular location or time into the trip or within a range of locations or times. Some hazards may only be available for certain trips or may be required for certain trips and may be locked out (the user 58 may be unable to turn them on) if the hazard is not currently available for the trip selected in the trip selection section 382. For example, the pedestrians hazard may not be available in a trip along a country or mountain road.

Clicking or highlighting each of the listed hazards may cause a description of the hazard to appear in the hazard summary section 386. Also, while an individual hazard is selected, the user 58 can designate a likelihood of the occurrence for the hazard using a likelihood of occurrence selection tool 388. The occurrence selection tool 388 allows the user 58 to designate a 0% to 100% chance of occurrence. In addition to specifying a likelihood of occurrence for each of the selected hazards, the user 58 may designate a risk factor using the risk factor selection tool 390. The risk factor selection tool 390 allows the user 58 to specify whether a hazard has a low, medium, or high risk. The higher the selected risk, the more difficult the hazard will be to avoid or handle correctly or safely.

After the user 58 has selected and configured the hazards for a trip, the user 58 may select an environment or atmosphere for the trip from the atmosphere selection section 392. The atmosphere selection section 392 allows the user 58 to designate the time of day of the trip, the weather the trip should take place in, the season the trip should take place in, or the like. Selecting parameters from the atmosphere selection section 392 may invalidate a hazard previously selected in the hazard selection. For example, the black ice hazard may not be available or a valid hazard choice if the user 58 selects summer as the season for the trip. The user 58 may be required to modify the selected hazard, or it may be automatically adjusted or turned off based on the selections of the user in the atmosphere selection section 392.

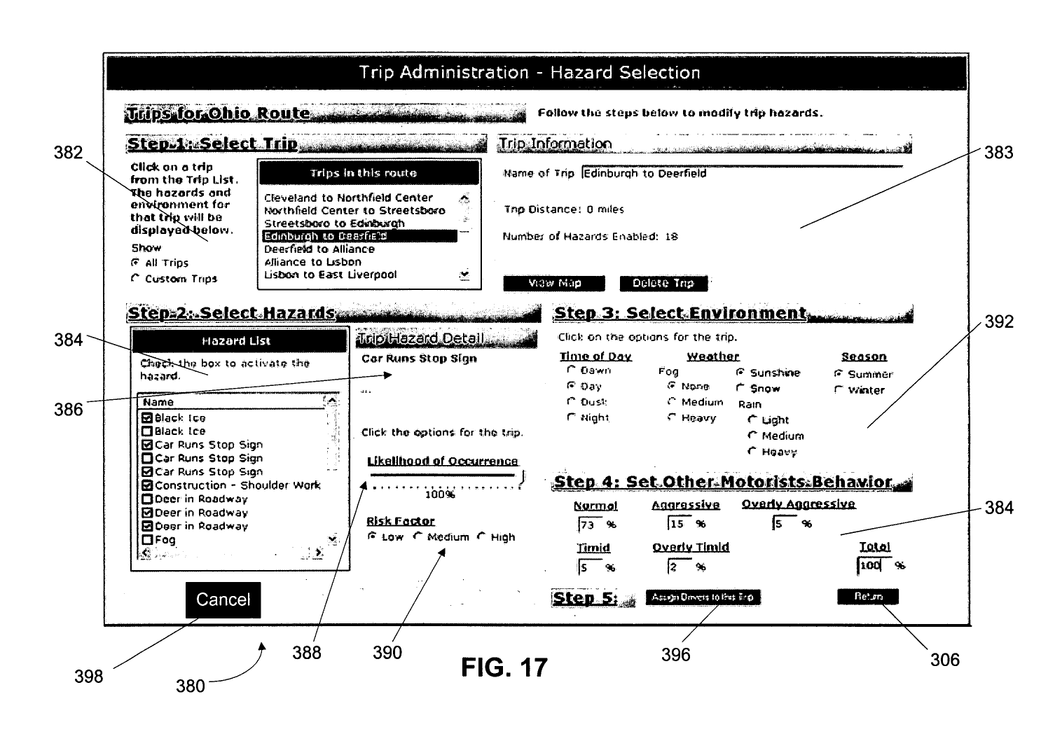

In some embodiments, the user 58 specifies the behavior of the other motorists that will be present on the selected trip using the profile selection section 394. The profile selection section 394 allows the user to designate an artificial intelligence profile for the simulated intelligent vehicles included in the simulated driving environment. As previously described, each simulated intelligent vehicle included in the simulated driving environment may have a profile including an aggression level that specifies how the simulated intelligent vehicle will operate. In some embodiments, the available aggression levels may include normal, aggressive, overly aggressive, timid, and overly timid. The profile selection section 394 allows a user to specify the percentage of the simulated intelligent vehicles present in the simulated driving environment that will be assigned each of the available aggression levels. In the example provided in FIG. 17, 73% of the simulated intelligent vehicles should have profiles specifying normal aggression levels, 15% have an aggressive aggression level, 5% have an overly aggressive aggression level, 5% have a timid aggression level, and 2% have an overly timid aggression level. The percentages supplied by the user 58 should total 100% and may be automatically adjusted if the total is not 100%, or an error message may be generated alerting the user 58 to modify the supplied percentages.

After the user 58 has specified the parameters for the trip, the user 58 may click the commit button 396 to save the trip including the parameters and assign drivers to the trip. Alternatively, the user 58 may click the cancel button 398.

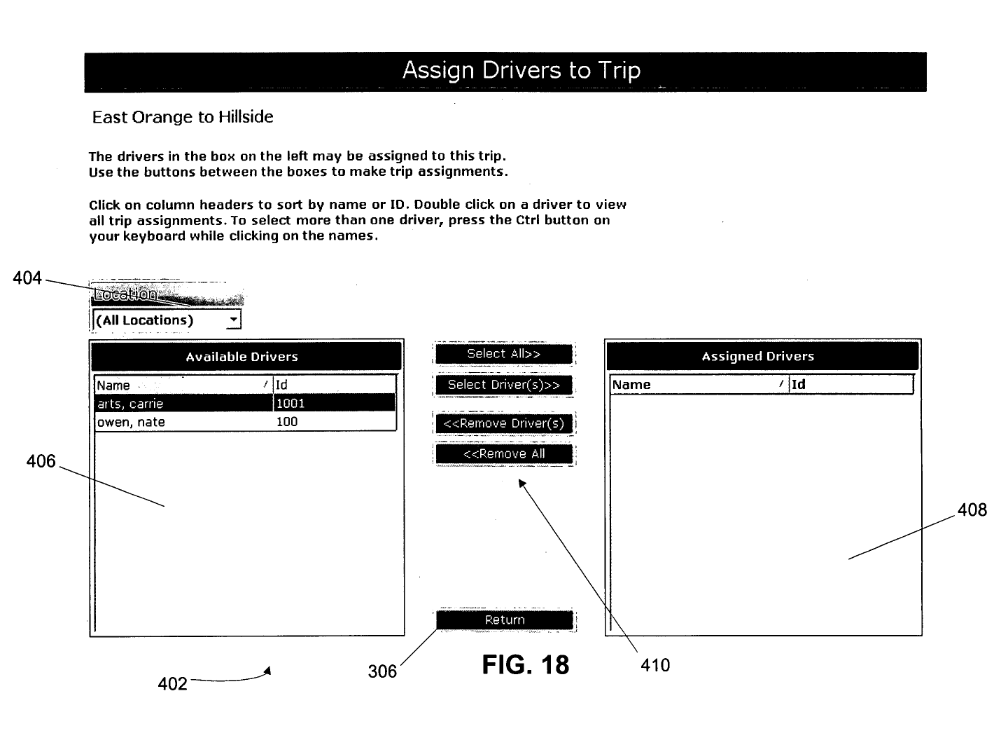

If the user 58 clicks the commit button 396, a driver assignment screen 402 may be presented to the user 58, as seen in FIG. 18. The driver assignment screen 402 includes a location drop-down tool 404, an available driver list 406, an assigned drivers list 408, a select section 410, and the return button 306. The user 58 may use the location drop-down tool 404 to select a particular location and filter the available drivers that are listed in the available driver list 406. The user 58 may then use the buttons in the select section 410 to assign and unassign drivers listed in the available driver list 406 to the trip previously configured. The user 58 may select an individual driver or all drivers from the available driver list 406 and assign them to the configured trip. The user 58 may also remove or unassign a particular driver or all drivers previously assigned to the trip.

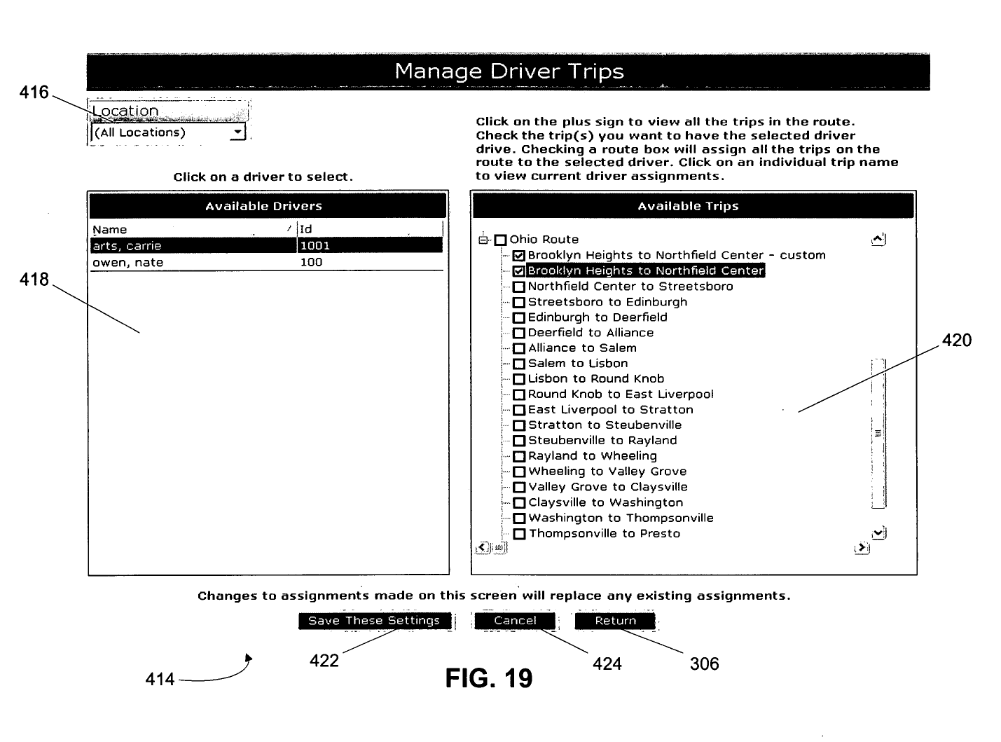

After the user 58 has assigned drivers to trips, the user 58 may review all the assignments using a trip management screen 414 (FIG. 19). The trip management screen 414, which may be accessed from the preliminary setup screen 300, includes a location drop-down tool 416, an available driver list 418, an available trip list 420, a commit button 422, a cancel button 424, and the return button 306. The user 58 may use the location drop-down tool 416 to select a particular location and filter or limit the drivers that are listed in the available driver list 418. After clicking on or selecting one of the drivers listed in the available driver list 418, the available trip list 420 displays all the available trips and indicates whether the selected driver is assigned to each. For example, each trip that is assigned to the selected driver may be highlighted or be checked as illustrated in FIG. 19. In addition to viewing the assigned trips, the user 58 may also be allowed to modify assignments. The user 58 may check and uncheck the boxes displayed next to each trip to assign and unassign trips. The user 58 may click the commit button 422 to save all assignments made on the trip management screen 414. In some embodiments, modifications made to trip assignments on the trip management screen 414 override previous assigns made on the driver assignment screen 402. If the user 58 wishes to disregard any changes made to trip assignments using the trip management screen 414, the user 58 may click the cancel button 424 or return button 306.

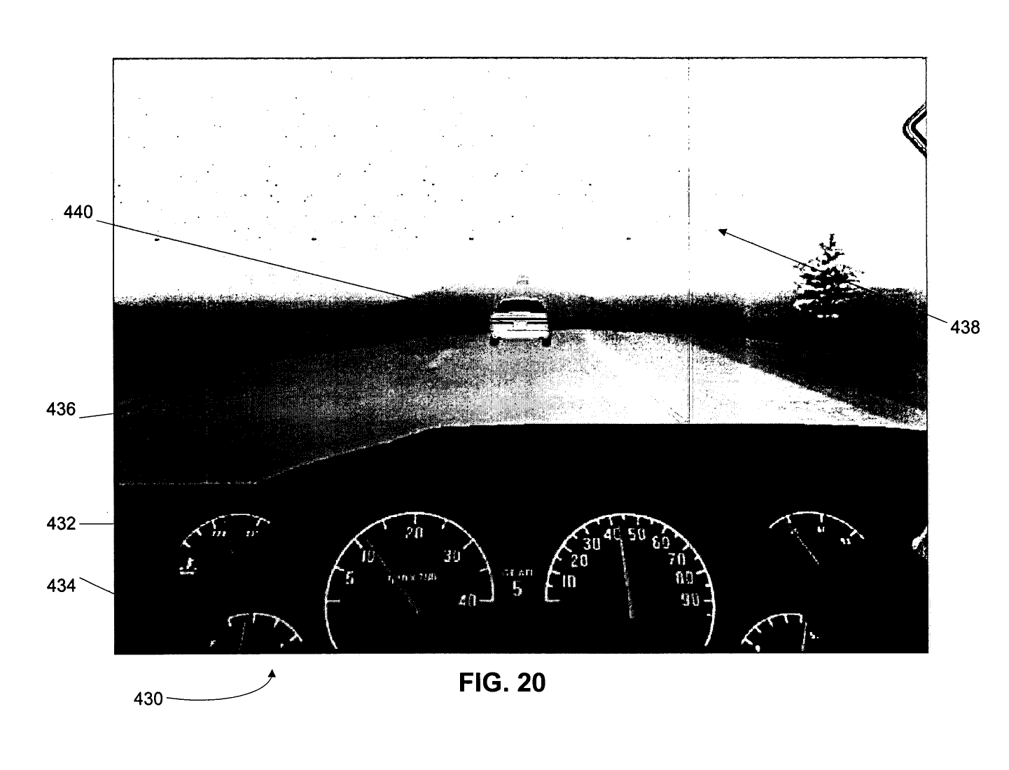

The settings and parameters specified by the user 58 when assigning trips may be saved to the trip database 90 or administration database 88. When the user 58 (or other driver other than the individual that assigned the trip) logs onto the driving simulator 50, the list of assigned trips may be accessed and displayed, allowing the user 58 or other driver to select an assigned trip to perform. Upon a selection by the user 58 of an assigned trip, the driving simulator 50, or more particularly, the simulator module 72, creates a simulated driving environment for the user 58 or driver based on the parameters set when the trip was assigned. The driving simulator 50 presents the simulated driving environment to the user 58 on the display 60. An exemplary simulated environment screen shot 430 is illustrated in FIG. 20. The screen shot 430 includes a simulated dashboard 432 including a simulated steering wheel 434; a simulated road 436; a simulated landscape 438 including displayed trees, grass, buildings, street signs, and the like; and a simulated intelligent vehicle 440. The driving simulator 50 changes the simulated dashboard 432 including the steering wheel 434, road 436, landscape 438, and intelligent vehicle 440 based on the input provided by the user 58 through the input devices.

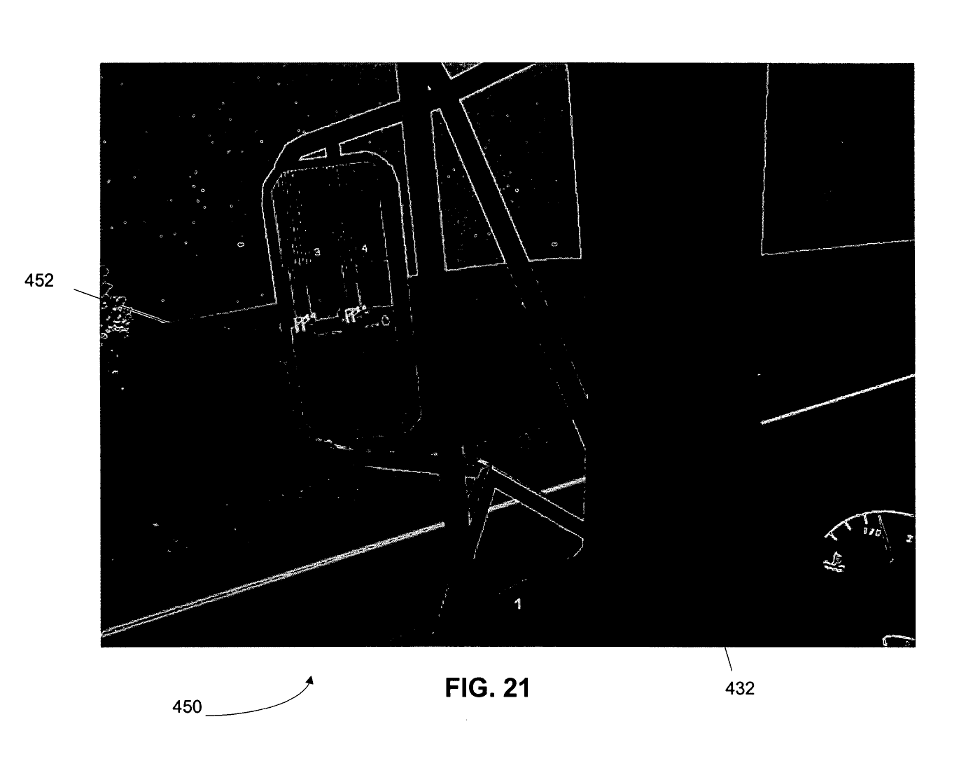

The screen shot 430 illustrates a direct or forward view such as would be seen looking straight out of a windshield of an actual vehicle. The user 58 uses the input devices such as the steering wheel input device 54 and pedal input device 56 to control the simulated vehicle through the simulated environment. FIG. 21 illustrates another exemplary simulated environment screen shot 450. Screen shot 450 represents a side view such as would be seen looking out a passenger or door window of an actual vehicle. A similar side view may be available for simulating the environment observed outside the opposite side window. The side view includes a simulated mirror 452 that simulates what would be seen in side mirrors attached to an actual vehicle. The user 58 may use the simulated mirror 452 to view a mirrored simulated environment behind and to the side of the simulated vehicle operated by the user 58. The user 58 can use an input device to change the displayed view. For example, the user 58 may push a button on the steering wheel input device 54 that switches the displayed view from a direct view, as illustrated in FIG. 20, to a side view as illustrated in FIG. 21.

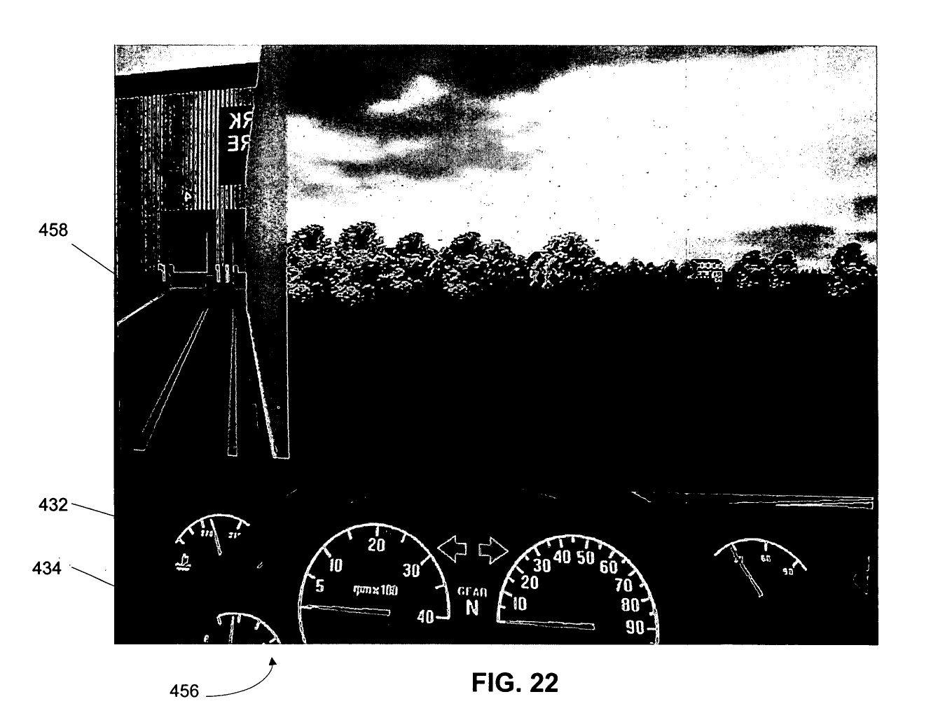

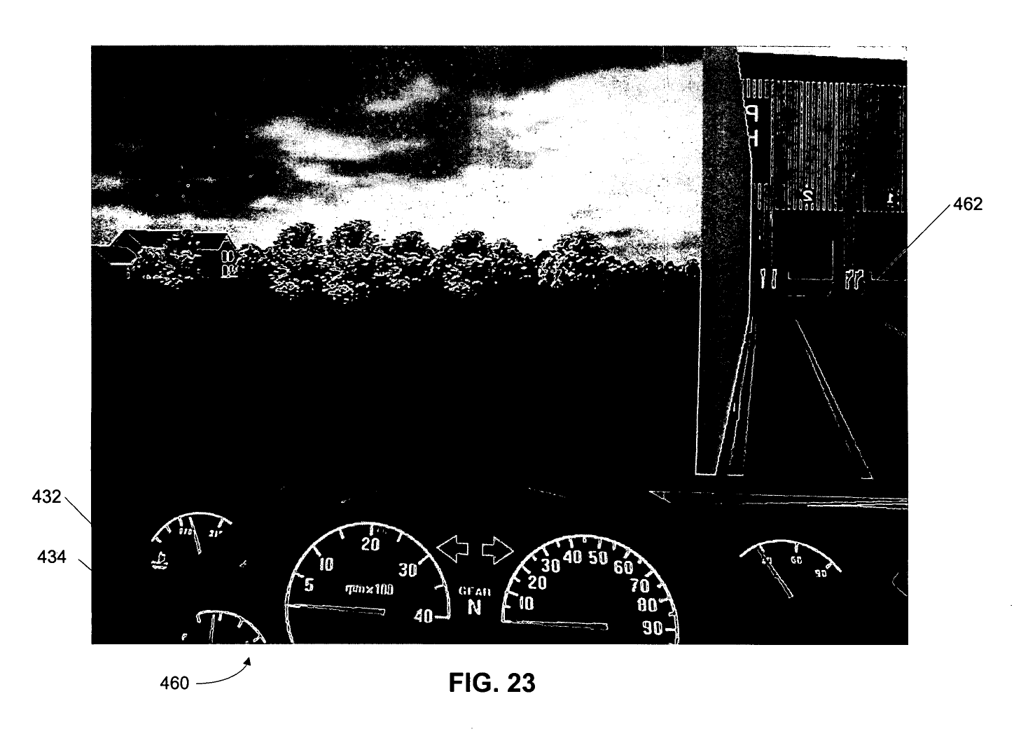

Rather than changing from a direct view to a side view, where the road in front of the user 58 cannot be seen, the user may select a combination screen where the simulated mirrored environments presented in the simulated mirror 452 is displayed with the direct view. FIG. 22 illustrates yet another exemplary screen shot 456 representing a direct view, as seen in FIG. 20, with the mirrored simulated environment 458, as presented in the simulated mirror 452 in FIG. 21, superimposed thereon. This type of screen allows the user 58 to maintain the direct view while viewing mirror views at the same time. The user 58 may toggle the display of this type of combination screen using a selection mechanism such as a button or lever on the steering wheel input device 54. The user 58 may use the superimposed or inserted mirror view to operate the simulated vehicle in reverse. The user 58 may display both a left-side mirror view, as illustrated in FIG. 22, and a right-side mirror view as illustrated in screen shot 460 of FIG. 23. Similar to the mirrored simulated environment 458 shown in FIG. 22, FIG. 23 illustrates another mirrored simulated environment 462 from a right-side mirror. The user 58 may display both mirrored simulated environments 458 and 462 simultaneously, or may display each of them separately.

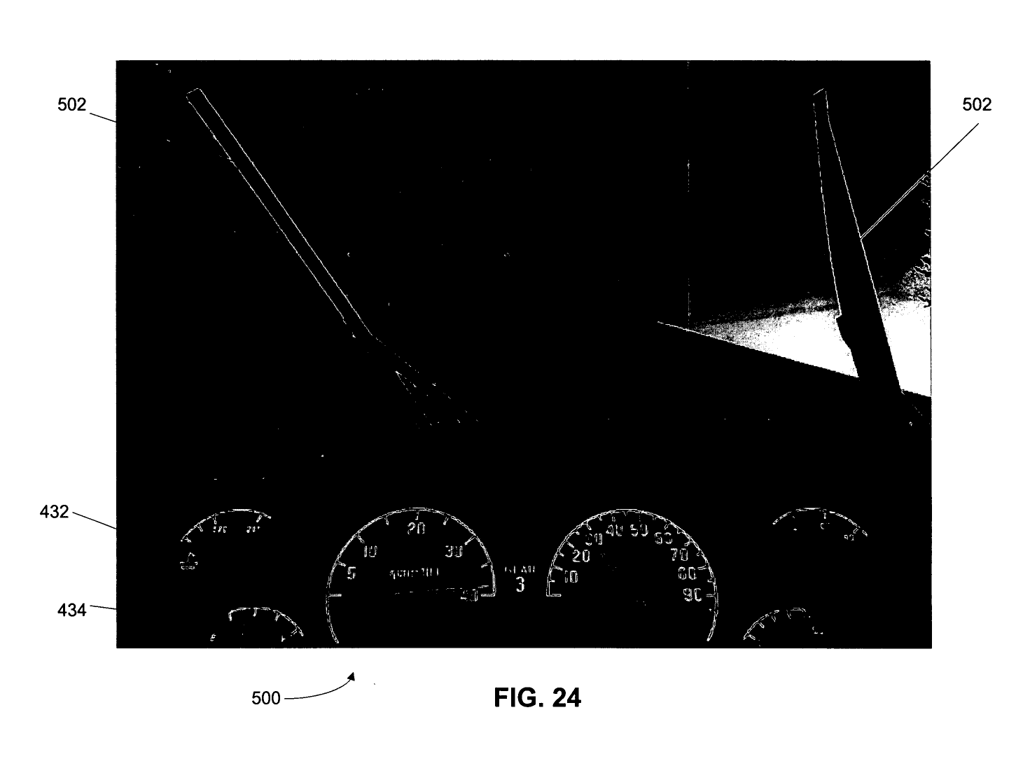

FIG. 24 illustrates an exemplary direct view screen shot 500 containing a simulated weather condition. Although snow is illustrated other weather and atmosphere conditions may be simulated including rain, fog, ice, hail, dusk/dawn, direct sunlight, road glare, or the like. Simulated windshield wipers 502 are also illustrated in the screen shot 500. The simulated windshield wipers 502 may operate as normal wipers and move across the simulated windshield displayed to the user 58. In some embodiments, the user 58 turns the simulated windshield wipers on and off using controls present on the steering wheel input device 54.

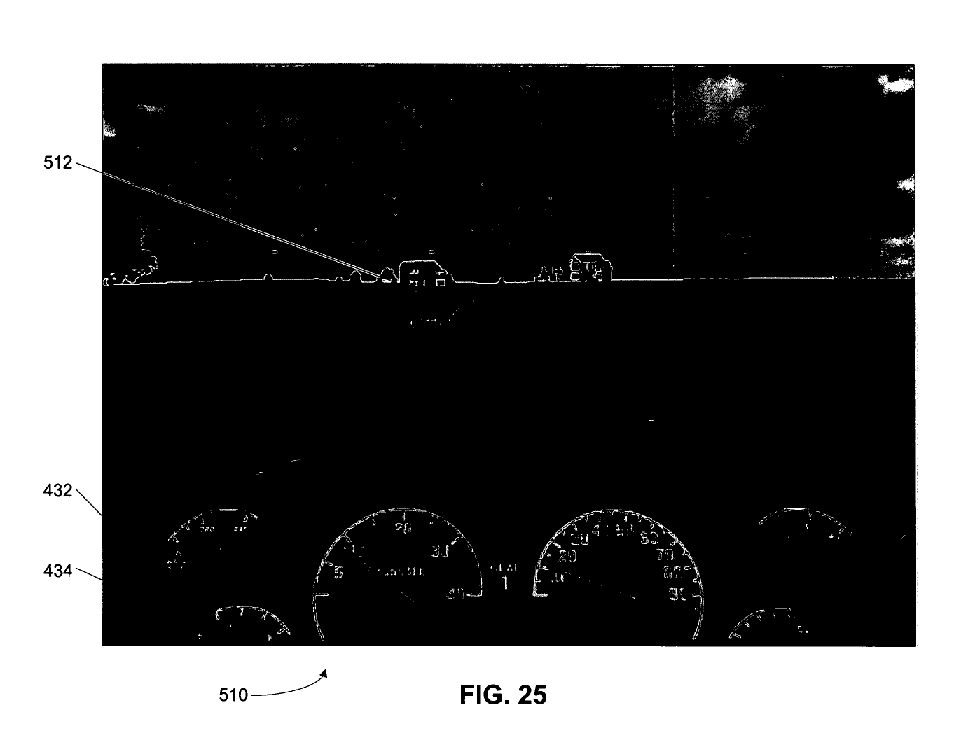

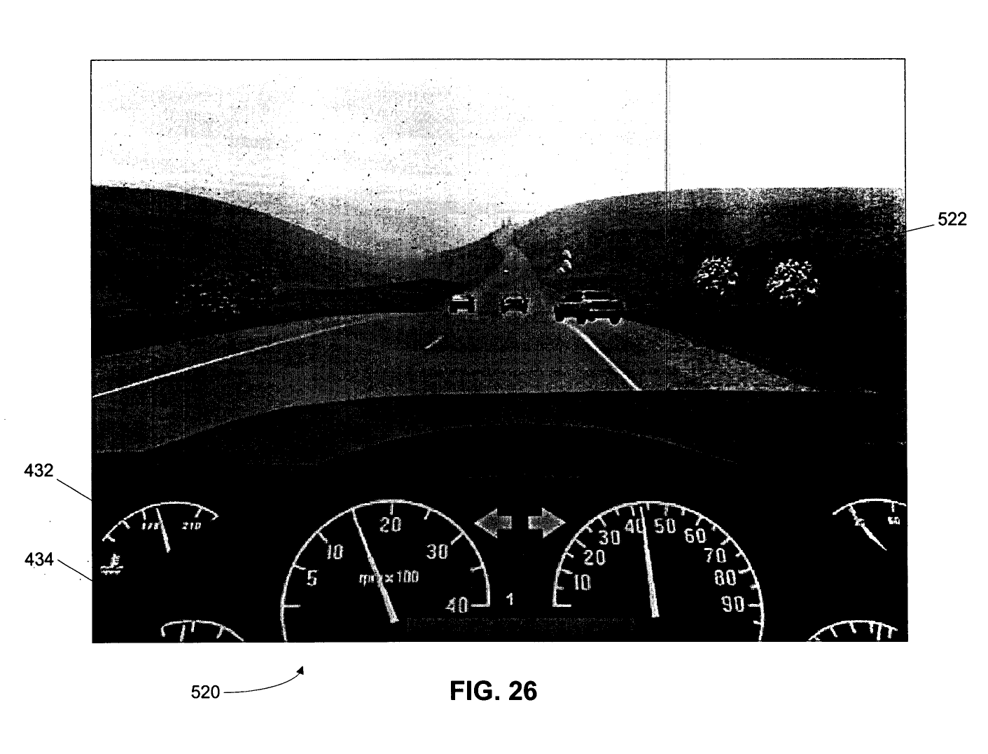

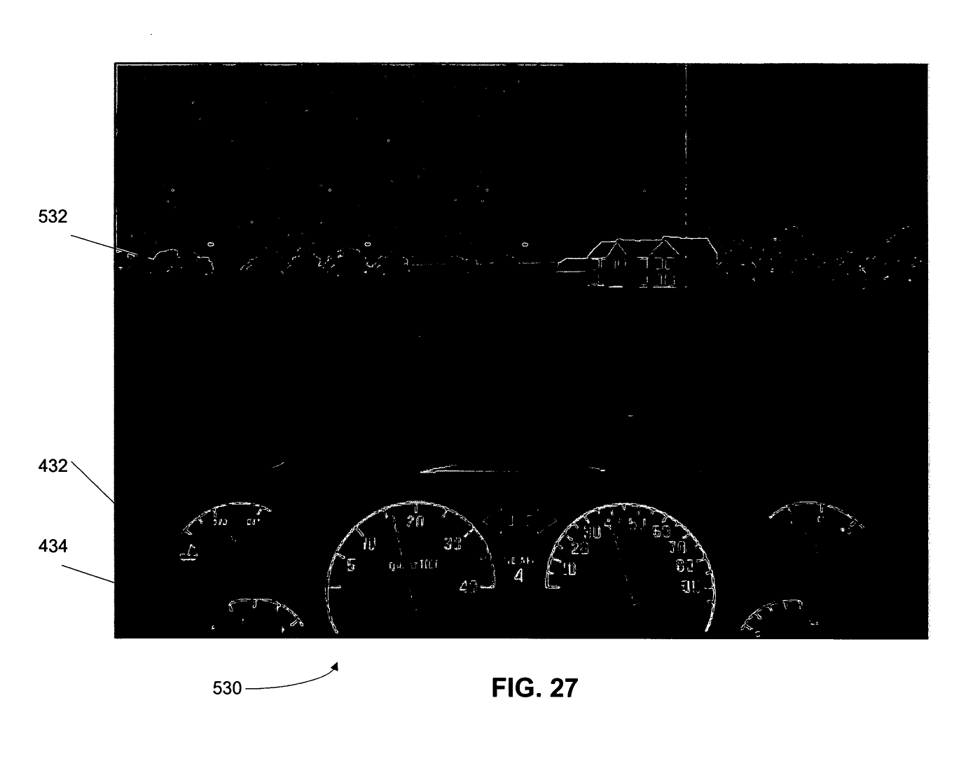

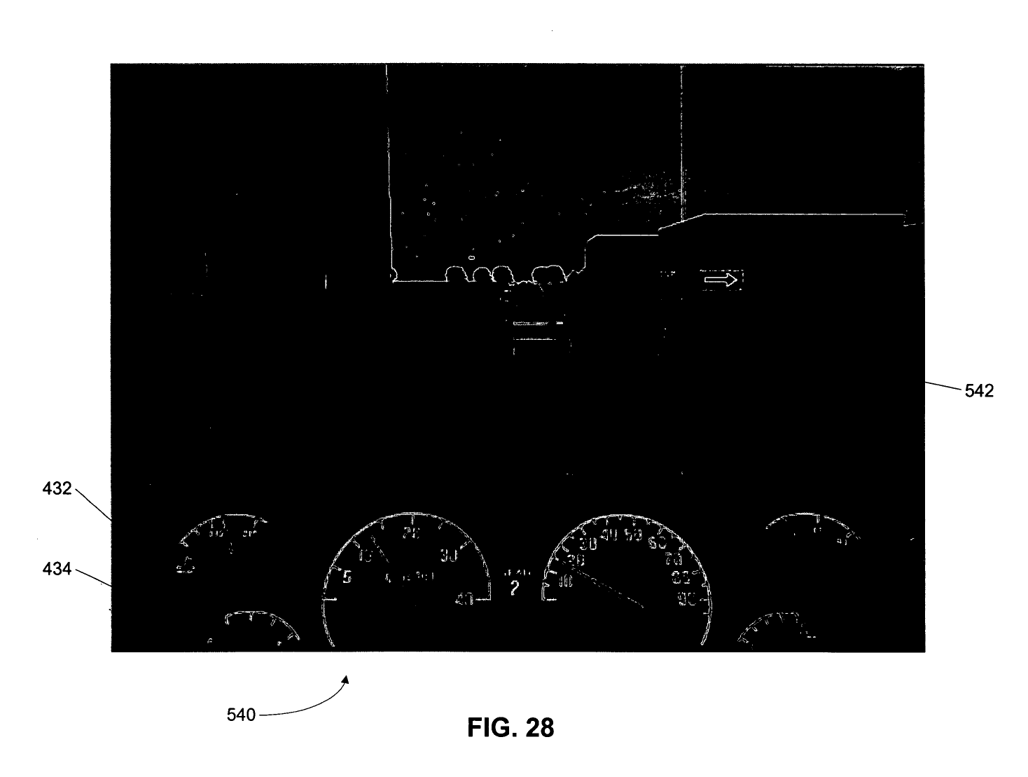

FIGS. 25-28 represent exemplary simulated hazards that may be presented to the user 58. For example, FIG. 25 is a screen shot 510 displaying a simulated cow 512 in the road. FIG. 26 is a screen shot 520 illustrating a simulated car 522 pulling out from the shoulder of a road. FIG. 27 is a screen shot 530 illustrating a simulated object 532 in the road. FIG. 28 is a screen shot 540 illustrating a simulated pedestrian 542 crossing the road. Other types of hazards are possible such as a car running a stop light, a car stopping suddenly, a construction site or lane closure, or the like.

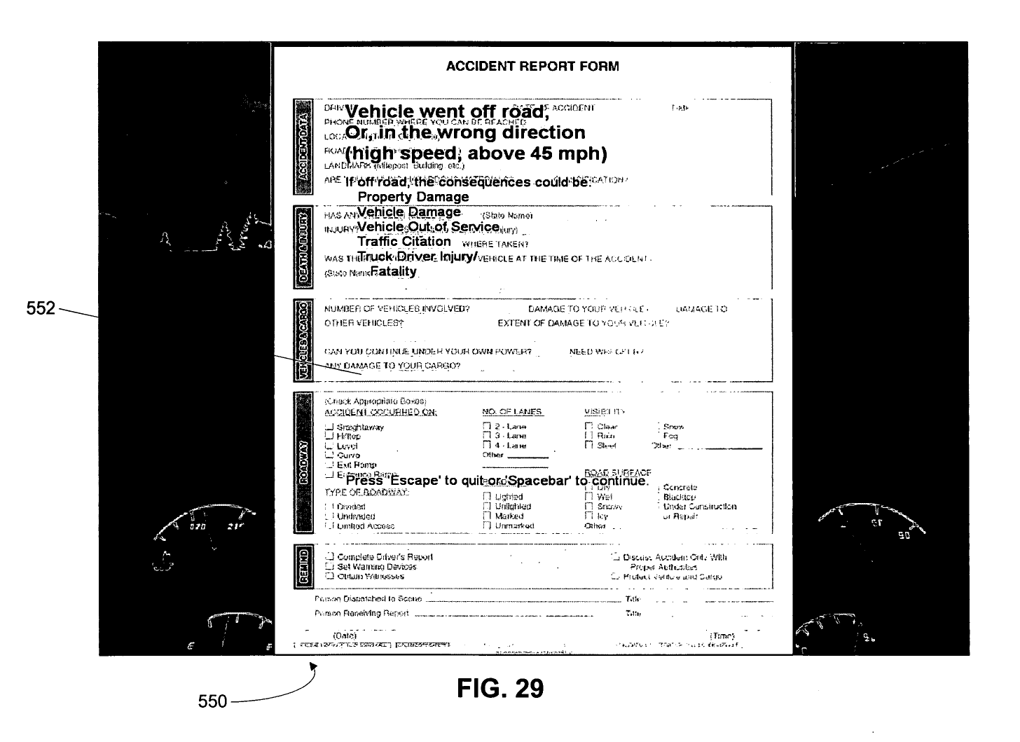

If the user 58 is involved in an accident or an infraction, the driving simulator 50 may display an accident screen shot 550, as is illustrated in FIG. 29. The accident screen shot 550 includes an accident report 552 that lists the type of accident or infraction occurred and possible outcomes or consequences of the accident. For example, the accident report 552 illustrated in FIG. 29 lists the possible consequences of driving off the road. The consequences include property damage, vehicle damage, traffic violation, and driver injury or fatality. The accident report 552 provides immediate feedback to the user 58 when the user 58 performs dangerous or life-threatening action.

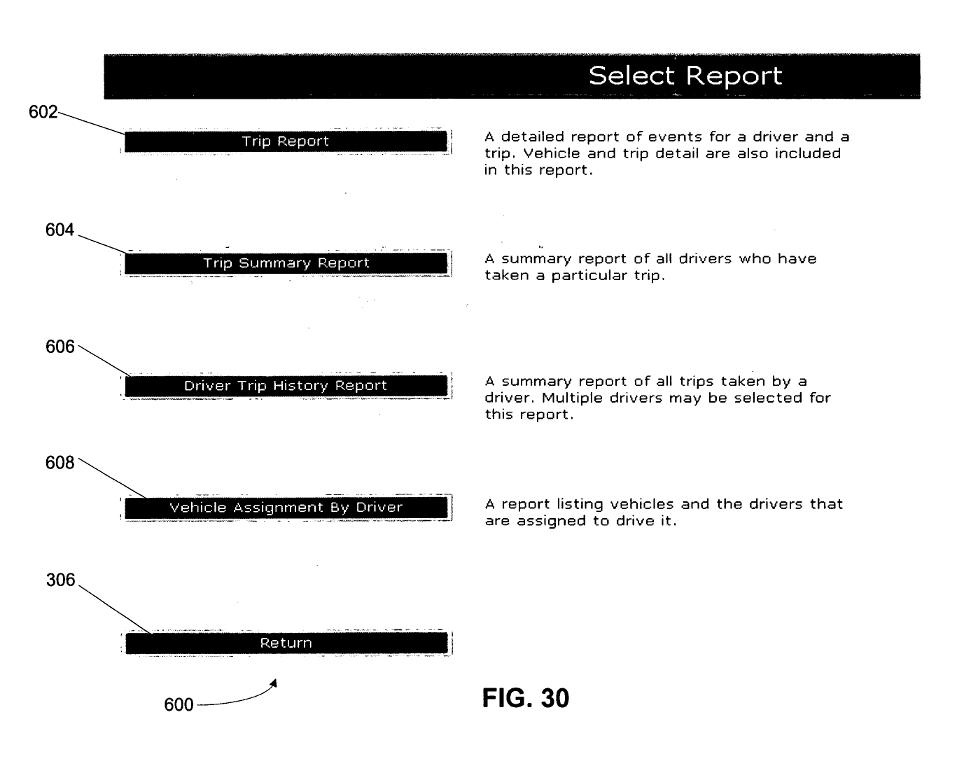

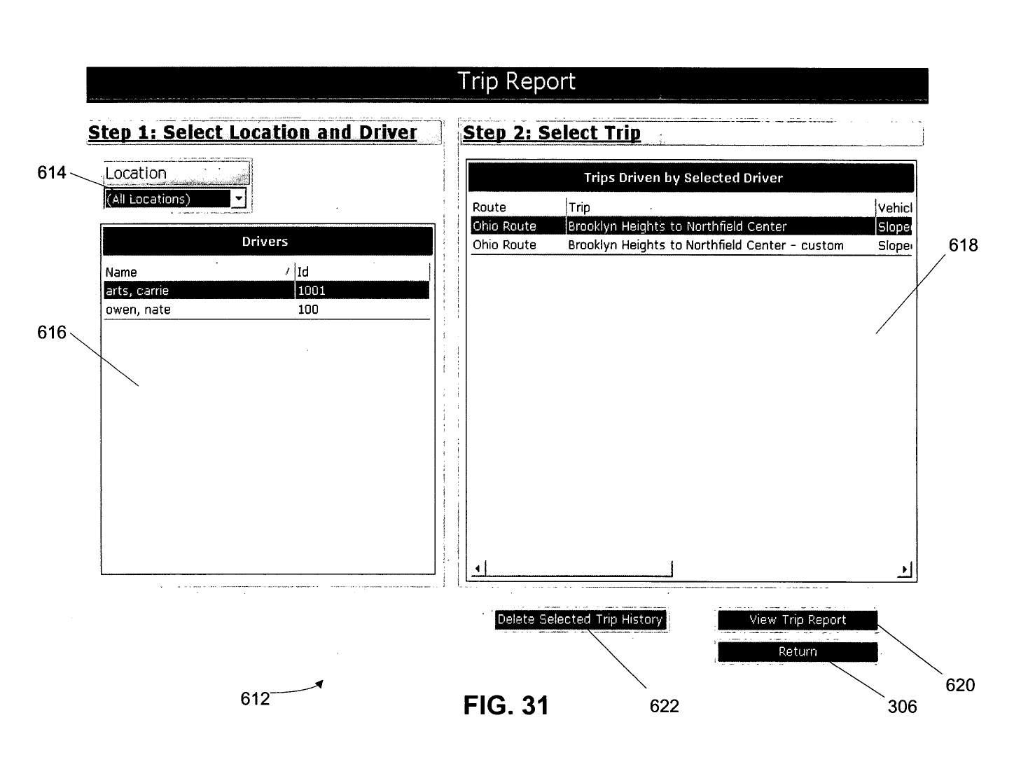

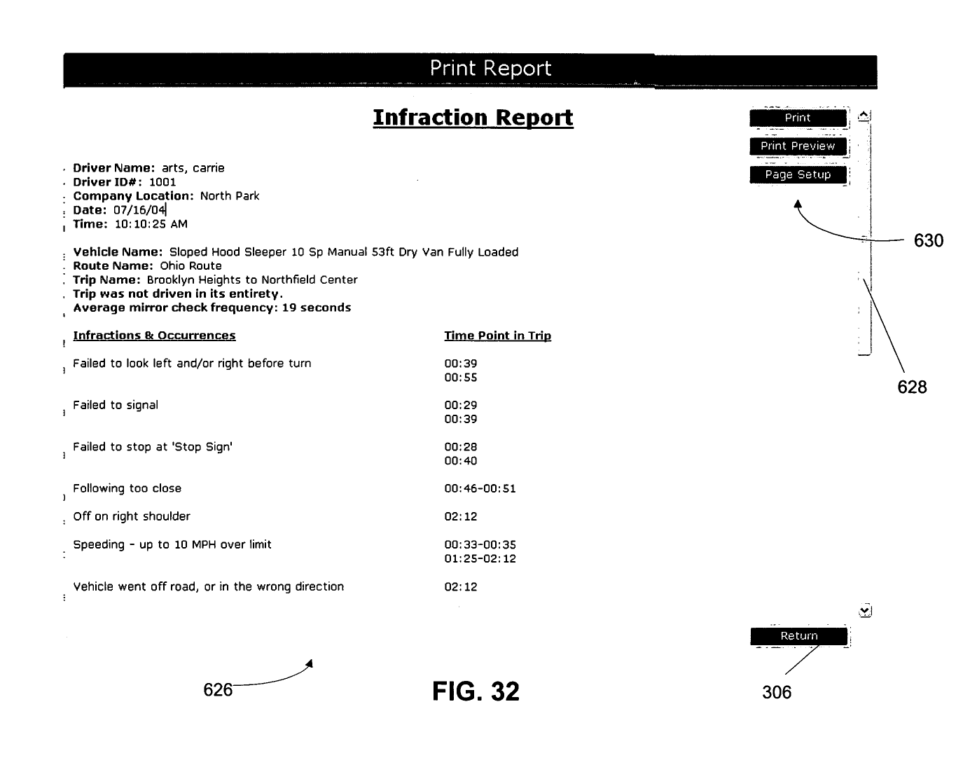

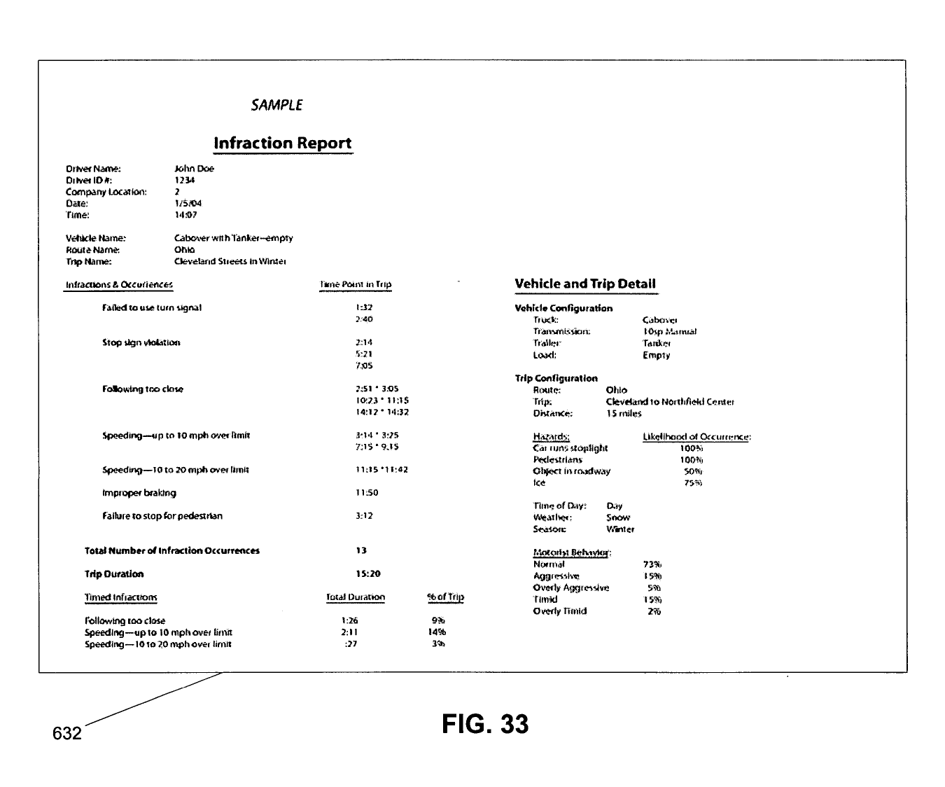

While the user 58 performs the simulated trip, the recording manager 111 records operational data. The operational data may include infractions or events performed by the user 58 such as speeding, running a red light, following too close, driving without headlights, insufficient mirror use, or the like. The recording manager 111 may also record the time or range of times during the simulated trip when the events occurred. The operational data may also include information regarding the simulated trip performed such as a trip name; a time of day; a number of miles; a listing of activated hazards, likelihood of occurrence, and risk factor; or the like. The operational data may be available for review by the user 58, or another individual monitoring the performance of the user 58. The user 58 may use a report screen 600, as seen in FIG. 30, to view the operational data collected during a performed trip. The report screen 600 may be accessed through the preliminary setup screen 300. The report screen 600 includes a trip report button 602, a trip summary report button 604, a driver trip history report button 606, a vehicle-assignment-by-driver report button 608, and the return button 306. If the user clicks the trip report button 602, a trip report screen 612 may be displayed, as seen in FIG. 31. The trip report screen 612 includes a location drop-down tool 614, an available driver list 616, a driven trips list 618, a view report button 620, a delete report button 622, and the return button 306. The user 58 may use the location drop-down tool 614 to select a particular location and filter the drivers displayed on the available driver list 616. In some embodiments, clicking or selecting a driver from the available driver list 616, causes the trips performed by that driver to be displayed on the driven trips list 618. The user 58 can then choose a trip from the driven trips list 618 and click on or select the view report button 620. Selecting the view report button may cause the report associated with the selected trip to be displayed to the user 58 on the display 60 such as is illustrated in FIG. 32. The displayed report screen 626 displays the operational data recorded for the selected trip and allows the user 58 to scroll through the data using a scroll bar 628 on the right-hand side of the screen 626. The displayed report screen 626 also includes a print section 630 and the return button 306. The print section 630 provides functionality to the user 58 to print the displayed report, to preview a print of the displayed report, or setup the printing of the displayed report. Other functionality may be provided to the print section 630 such as saving the displayed report to a file or database or emailing the displayed report. Printing the displayed report may result in a hardcopy report 632 as seen in FIG. 33.

FIG. 31 illustrates dialogs for managing reports. The user 58 may select the delete report button 622 to delete the stored operational data. This may be done after the user 58 reviews the operational data or if the data has been moved to a more permanent data storage location. In addition, the user 58 may specify a trip summary report that combines the operational data for all drivers that have performed a selected trip. The user 58 may also specify a date range to include only the operational data for a particular trip performed by all drivers within the designated date range. The user 58 may also specify particular drivers to include for the summary report, such as all drivers, all drivers from a particular location, or particular drivers. The user 58 may also request a driver trip history report that combines the operational data for all trips performed by a particular driver. The user 58 may set a date range for trips to be included in the report and may designate particular trips that should be included or excluded. These reports may be displayed to the user 58 in a similar manner as illustrated in FIG. 32 and may be printed out or processed accordingly.

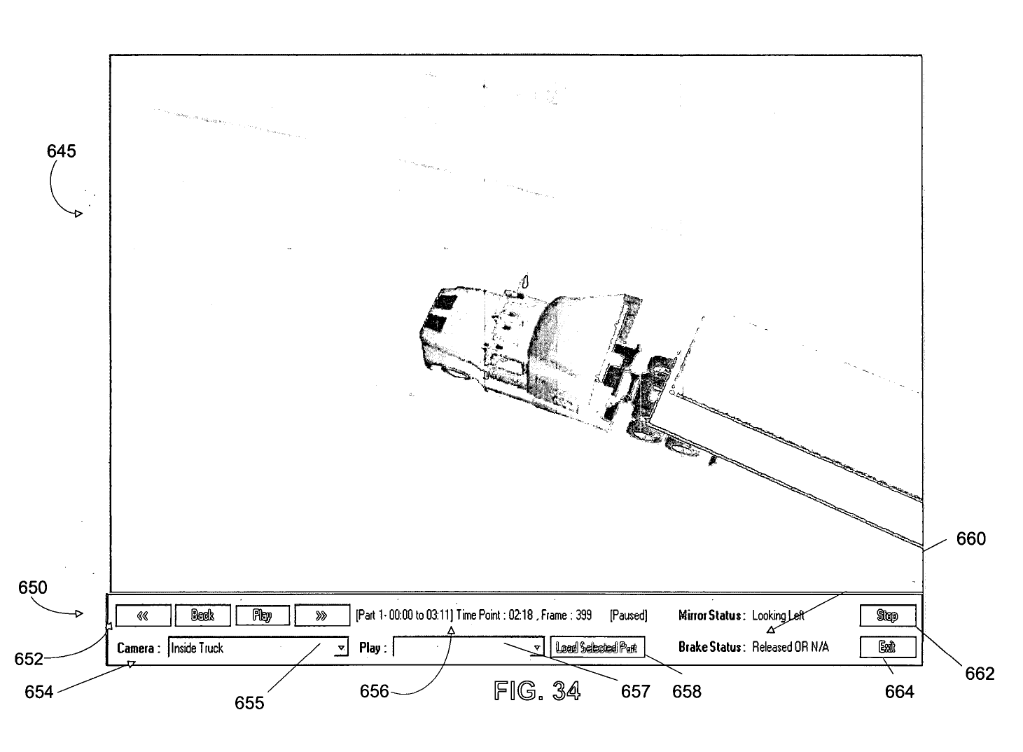

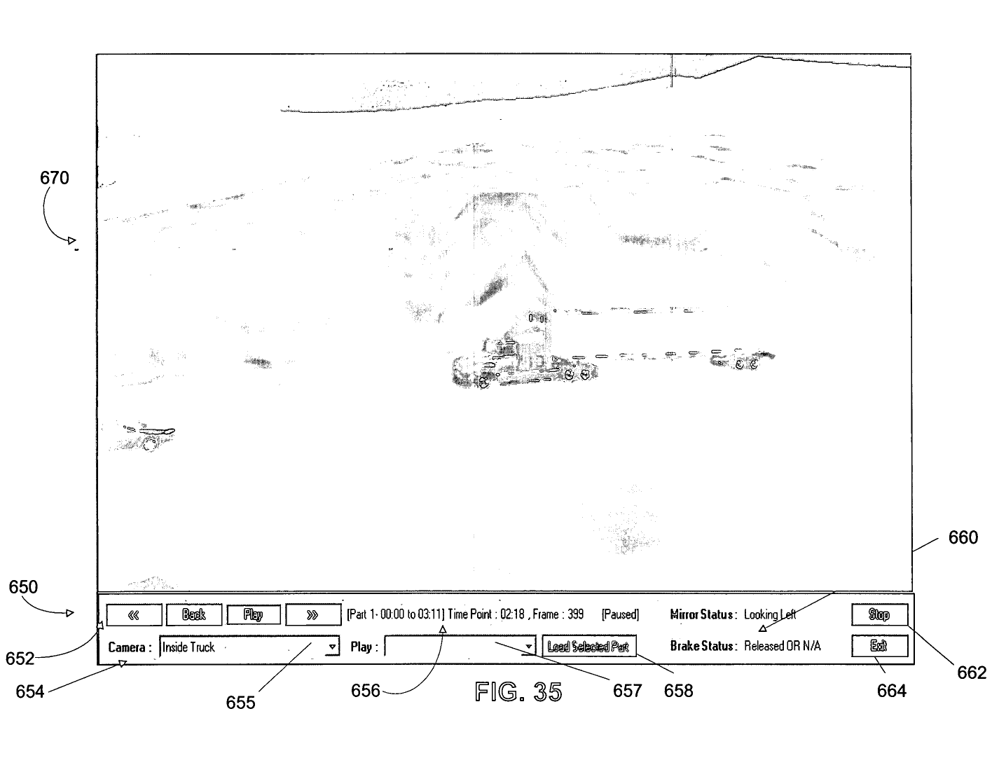

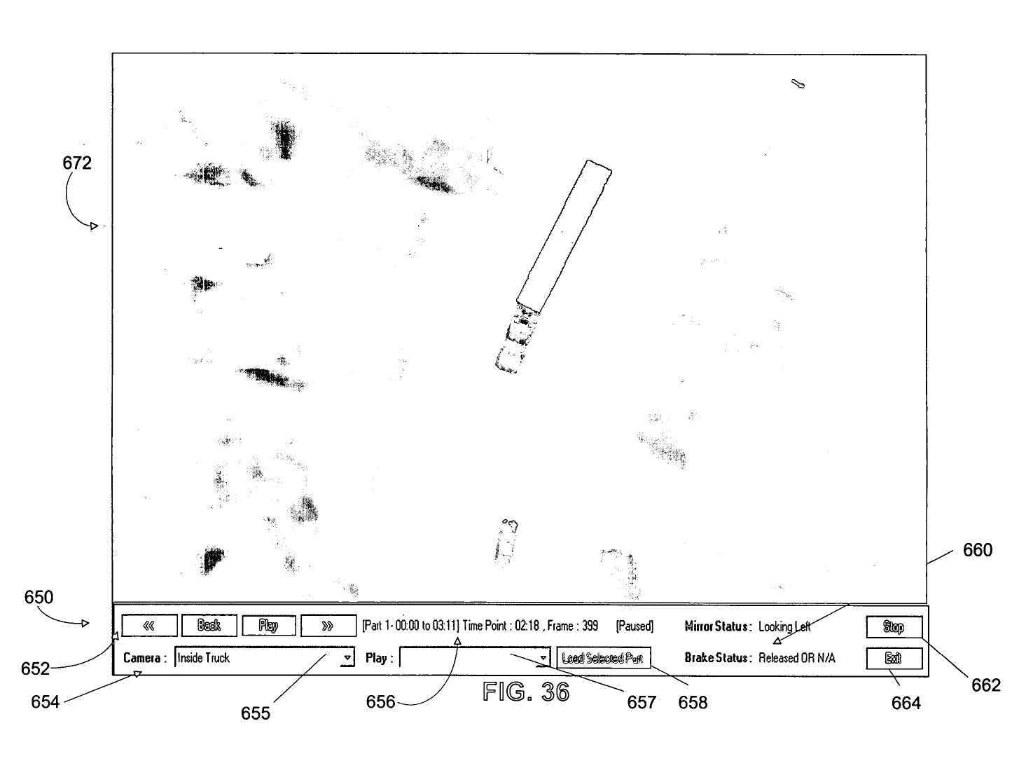

The recording manager 111 may also record operational data that allows the performed trip to be replayed to the user 58 or other individual assessing performance. In some embodiments, the recording manager 111 records every three frames displayed to the user 58 on the display 60 so that the performed simulated trip can be replayed. As previously described, the player module 78 may be configured to replay the recorded frames and may also be able to change the camera view of the replay. FIGS. 34-36 illustrates exemplary screen shots generated during the replay. Each screen illustrates a particular camera angle or view. Each screen shot also includes a status and control toolbar 650. The status and control toolbar 650 includes a replay control section 652, a camera angle control section 654, a view drop-down tool 655, a time section 656, a section selection tool 657, a load selection button 658, a status section 660, a stop button 662, and an exit button 664. The replay control section 652 provides the user 58 with control over the playing, stopping, reversing, and fast forwarding of the displayed replay. The camera angle control section 654 displays the view of the currently displayed replay and provides the user 58 with the view drop-down tool 655 that switches the camera angle at which the replay is displayed.

The time section 656 indicates the time of the trip. The time may be represented by a time from the start of the trip, the frame number of the trip, or other timing mechanisms. The time indicated by the time section 656 may also be used to locate events that occurred during the trip, such as those events listed on the trip report. The time section 656 may also allow the user 58 to specify a particular time to jump to in the replay so that a particular time or time duration of the replay can be viewed without viewing the entire trip. The recorded trip may be divided into one or more sections that may be selected from the section selection tool 657. The user 58 may also be able to load specific parts of a trip from a file using the load section button 658. The load section button 658 may also be used to enter, or commit to, a selection made using the section selection tool 657.

The status section 660 indicates the operational data collected by the recording manager 111 that may be difficult to display visually during the replay. For example, the status section 660 may specify whether the brakes where applied or when the mirrors were checked.

The stop button 662 may be used to stop the currently displayed replay and the exit button 662 may be used to exit the replay screen and return to a previously displayed screen such as the main menu screen 250.

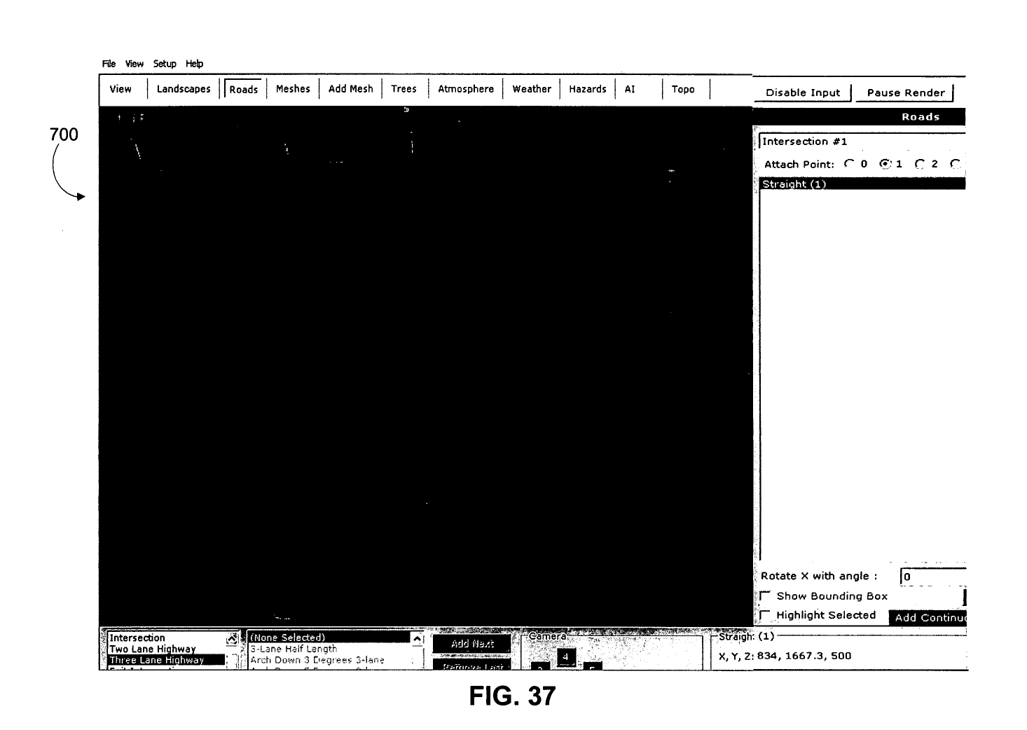

In some embodiments, the driving simulator 50 may be modified to create custom trips or vehicles. The customer trips and vehicle may be created to more closely replicate the true vehicles and trips taken by drivers. Editing tools may be used, such as a trip editor, vehicle editor, landscape editor, or the like, to create new simulated objects. FIG. 37 represents an exemplary screen shot 700 from a trip editor application. The user 58 or another individual such as a computer programmer may use a screen such as the editor screen 700 to generate a custom trip by piecing together road segments, landscape and scenery pieces, or the like. The user 58 may use editor application such as the trip editor to bend meshes, reapply road and scenery graphics, drop and drag trees, billboards, buildings, or other background objects into the trip, place and script hazards into the trip, or the like. The trip editor application, and other editor applications, may provide a user-friendly programming environment for quickly and efficiently generating new trip, vehicles, backgrounds, and the like.

As should be apparent to one of ordinary skill in the art, the screen shots and mechanisms presented in the figures are exemplary illustrations. Other configurations and designs are possible. The buttons, forms, and selection tools may be replaced by command inputs, key combinations, or alternative types of screen manipulation mechanisms. As should also be apparent, the systems shown in the figures are models of what actual systems might be like. Many of the modules and logical structures described are capable of being implemented in software executed by a microprocessor or a similar device or of being implemented in hardware using a variety of components including, for example, application specific integrated circuits (“ASICs”). Terms like “processor” may include or refer to both hardware and/or software. Furthermore, throughout the specification capitalized terms are used. Such terms are used to conform to common practices and to help correlate the description with the examples and drawings. However, no specific meaning is implied or should be inferred simply due to the use of capitalization. Thus, the claims should not be limited to the specific examples or terminology or to any specific hardware or software implementation or combination of software or hardware.

Various features and advantages of the invention are set forth in the following claims.

1-12. (canceled)

13. A driving simulator comprising:
a processor operable to fetch instructions from a computer-readable medium and execute the instructions;
a display connectable to the processor;
a plurality of input devices, including at least a steering wheel, a brake pedal, and an accelerator pedal, where each of the plurality of input devices is connectable to the processor; and
a computer-readable medium containing instructions for:
providing a plurality of simulated driving environments,
allowing a user to select one of the plurality of simulated driving environments,
allowing a user to provide trip parameters,
allowing a user to select a simulated vehicle,
activating zero or more hazards,
generating a plurality of simulated intelligent vehicles,
generating a profile for each of the plurality of simulated intelligent vehicles;
randomly assigning spawn points to each of the plurality of simulated intelligent vehicles,
displaying the simulated driving environment to a user and allowing the user to operate the simulated vehicle in the simulated driving environment using the plurality of input devices,
recording the operation of the simulated vehicle through the simulated driving environment, and
replaying the operation of the simulated vehicle.

14. A driving simulator as claimed in claim 13, wherein the display includes a plurality of displays simulating a plurality of views, wherein each of the plurality of views is a different view.

15. A driving simulator as claimed in claim 13, wherein the display includes a screen worn by a user.

16. A driving simulator as claimed in claim 13, wherein the plurality of input devices further includes at least one of a gear shift, directional light controls, headlight controls, windshield wiper controls, mirror controls, a clutch pedal, emergency brake control, and radio controls.

17. A driving simulator as claimed in claim 13, wherein the plurality of input devices further includes a tracking device operable to sense movement of a user.

18. A driving simulator as claimed in claim 13, further comprising a speaker.

19. A driving simulator as claimed in claim 13, wherein the computer-readable medium further contains instructions for authenticating a user.

20. A driving simulator as claimed in claim 13, wherein the computer-readable medium further contains instructions for generating a spawn point for each of the zero or more hazards.

21. A driving simulator as claimed in claim 13, wherein the computer-readable medium further contains instructions for recording a plurality of frames of the simulated driving environment.

22. A driving simulator as claimed in claim 13, wherein the computer-readable medium further contains instructions for changing a camera angle while replaying the operation of the vehicle.

23. A driving simulator as claimed in claim 13, wherein the computer-readable medium further contains instructions for displaying status information while replaying the operation of the simulated vehicle.

24. A driving simulator as claimed in claim 13, wherein the computer-readable medium further contains instructions for scoring the operation of the simulated vehicle.

25. A driving simulator as claimed in claim 13, wherein the computer-readable medium further contains instructions for specifying an aggression level for each of the plurality of simulated intelligent vehicles.

26. A driving simulator as claimed in claim 13, wherein the computer-readable medium further contains instructions for assigning a likelihood of occurrence to each of the zero or more hazards.

27. A driving simulator as claimed in claim 13, wherein the computer-readable medium further contains instructions for assigning a risk factor to each of the zero or more hazards.

28. A driving simulator as claimed in claim 13, wherein the computer-readable medium further contains instructions for displaying an infraction report during the operation of the simulated vehicle.

29. A driving simulator as claimed in claim 13, wherein the computer-readable medium further contains instructions for generating a printable report based on the operation of the simulated vehicle.

30. A method of generating a simulated driving environment, the method comprising:
generating a route;
generating one or more trips for the route;
generating one or more trip segments for the one or more trips;
creating zero or more hazards;
specifying a spawn point for each of the zero or more hazards; and
adding each of the zero or more hazards to at least one of the one or more trip segments.

31. A method as claimed in claim 30, further comprising specifying a likelihood of occurrence for each of the zero or more hazards.

32. A method as claimed in claim 30, further comprising specifying a risk factor for each of the zero or more hazards.

33. A method as claimed in claim 30, further comprising specifying a plurality of simulated intelligent vehicles.

34. A method as claimed in claim 33, further comprising specifying an aggression level for each of the plurality of simulated intelligent vehicles.

35. A method as claimed in claim 30, further comprising specifying trip parameters.

36. A method as claimed in claim 30, further comprising storing the simulated driving environment to a storage device.

37. A method of operating a driving simulator, the method comprising:
selecting a trip;
selecting trip parameters;
selecting a vehicle;
operating the vehicle on the selected trip; and
replaying the operation of the vehicle on the selected trip.

38. A method as claimed in claim 37, further comprising providing authentication information.

39. A method as claimed in claim 38, wherein providing authentication information includes providing a username and a password.

40. A method as claimed in claim 37, further comprising selecting a route, wherein the route includes one or more trips.

41. A method as claimed in claim 37, further comprising activating zero or more hazards.

42. A method as claimed in claim 41, further comprising specifying a likelihood of occurrence for each of the zero or more hazards.

43. A method as claimed in claim 41, further comprising specifying a risk factor for each of the zero or more hazards.

44. A method as claimed in claim 37, further comprising specifying an artificial intelligence profile for a plurality of simulated intelligent vehicles.

45. A method as claimed in claim 44, wherein specifying an artificial intelligence profile includes selecting an aggression level.

46. A system for training a driver, the system comprising:
a plurality of input devices, including at least a steering wheel, a brake pedal, and an accelerator pedal, where each of the plurality of input devices is connectable to a processor; and
a computer-readable medium containing instructions for:
providing a plurality of simulated driving environments,
allowing a user to select one of the plurality of simulated driving environments,
allowing a user to provide trip parameters,
allowing a user to select a simulated vehicle,
activating zero or more hazards,
generating a plurality of simulated intelligent vehicles,
generating a profile for each of the plurality of simulated intelligent vehicles;
randomly assigning spawn points to each of the plurality of simulated intelligent vehicles,
displaying the simulated driving environment to a user and allowing the user to operate the simulated vehicle in the simulated driving environment using the plurality of input devices,
recording the operation of the simulated vehicle through the simulated driving environment, and
replaying the operation of the simulated vehicle.

47. A system as claimed in claim 46, wherein the plurality of input devices further include at least one of a gear shift, directional light controls, headlight controls, windshield wiper controls, mirror controls, a clutch pedal, emergency brake control, and radio controls.

48. A system as claimed in claim 46, wherein the plurality of input devices further includes a tracking device operable to sense movement of the user.

49. A system as claimed in claim 46, further comprising one or more displays.

50. A system as claimed in claim 49, wherein the one or more displays include a screen worn by a user.

51. A system as claimed in claim 46, further comprising a speaker.

52. A system as claimed in claim 46, wherein the computer-readable medium further contains instructions for authenticating a user.

53. A system as claimed in claim 46, wherein the computer-readable medium further contains instructions for generating a spawn point for each of the zero or more hazards.

54. A system as claimed in claim 46, wherein the computer-readable medium further contains instructions for recording a plurality of frames of the simulated driving environment.

55. A system as claimed in claim 46, wherein the computer-readable medium further contains instructions for changing a camera angle while replaying the operation of the vehicle.

56. A system as claimed in claim 46, wherein the computer-readable medium further contains instructions for displaying status information while replaying the operation of the simulated vehicle.

57. A system as claimed in claim 46, wherein the computer-readable medium further contains instructions for scoring the operation of the simulated vehicle.

58. A system as claimed in claim 46, wherein the computer-readable medium further contains instructions for specifying an aggression level for each of the plurality of simulated intelligent vehicles.

59. A system as claimed in claim 46, wherein the computer-readable medium further contains instructions for assigning a likelihood of occurrence to each of the zero or more hazards.

60. A system as claimed in claim 46, wherein the computer-readable medium further contains instructions for assigning a risk factor to each of the zero or more hazards.

61. A system as claimed in claim 46, wherein the computer-readable medium further contains instructions for displaying an infraction report during the operation of the simulated vehicle.

62. A system as claimed in claim 46, wherein the computer-readable medium further contains instructions for generating a printable report based on the operation of the simulated vehicle.

63. A system for administrating the training of a plurality of drivers, the system comprising:
one or more client computers configured to execute a driving simulator, to log operational data of the executed driving simulator, and to provide a data storage device with the operational data;
the data storage device configured to receive the operational data of the driving simulator from the one or more client computers, to store the operational data, and to provide access to the operational data by an administrative computer; and
the administrative computer configured to access the operational data, to specify a camera angle, to replay the operational data, and to modify the camera angle.

64. A system as claimed in claim 63, wherein the one or more client computers are further configured to accept authentication information from a user.

65. A system as claimed in claim 63, wherein the administrative computer is further configured to establish authentication information for a user.

66. A system as claimed in claim 63, wherein the administrative computer is further configured to generate simulated environments.

67. A system as claimed in claim 63, wherein the administrative computer is further configured to generated simulated vehicles.

68. A system as claimed in claim 63, wherein the administrative computer is further configured to assign simulated driving environments to a user.

69. A system as claimed in claim 63, wherein the one or more client computers are further configured to display assigned driving environments to a user.

70. A system as claimed in claim 63, wherein the one or more client computers are further configured to generate a report from the operational data.

71. A system as claimed in claim 63, wherein the administrative computer is further configured to generate a report from the operational data.

72. A system as claimed in claim 63, wherein the one or more client computers are further configured to replay the operational data, to specify a camera angle, to replay the operational data, and to modify the camera angle.

73. A system as claimed in claim 63, wherein the administrative computer is further configured to replay the operational data in at least one of a forward motion, a reverse motion, and a slow motion.

74. Computer readable medium containing instructions for:
providing a plurality of simulated driving environments;
allowing a user to select one of the plurality of simulated driving environments;
allowing a user to provide trip parameters;
allowing a user to select a simulated vehicle;
activating zero or more hazards;
generating a plurality of simulated vehicles;
generating a profile for each of the plurality of simulated intelligent vehicles;
randomly assigning spawn points to each of the plurality of simulated intelligent vehicles;
displaying the simulated driving environment to a user and allowing the user to operate the simulated vehicle in the simulated driving environment using the plurality of input devices;
recording the operation of the simulated vehicle through the simulated driving environment;
specifying a camera angle;
replaying the operation of the simulated vehicle; and
modifying the camera angle.

75. Computer-readable medium as claimed in claim 74, further containing instructions for authenticating a user.

76. Computer-readable medium as claimed in claim 74, further comprising generating a spawn point for each of the zero or more hazards.

77. Computer-readable medium as claimed in claim 74, further containing instructions for recording a plurality of frames of the simulated driving environment.

78. Computer-readable medium as claimed in claim 74, further containing instructions for displaying status information while replaying the operation of the simulated vehicle.

79. Computer-readable medium as claimed in claim 74, further containing instructions for scoring the operation of the simulated vehicle.

80. Computer-readable medium as claimed in claim 74, further containing instructions for specifying an aggression level for each of the plurality of simulated intelligent vehicles.

81. Computer-readable medium as claimed in claim 74, further containing instructions for assigning a likelihood of occurrence to each of the zero or more hazards.

82. Computer-readable medium as claimed in claim 74, further containing instructions for assigning a risk factor to each of the zero or more hazards.

83. Computer-readable medium as claimed in claim 74, further containing instructions for displaying an infraction report during the operation of the simulated vehicle.

84. Computer-readable medium as claimed in claim 74, further containing instructions for generating a printable report based on the operation of the simulated vehicle.

85. A module for managing a plurality of intelligent vehicles in a driving simulator, the module comprising:
a vehicle list specifying the plurality of intelligent vehicles where each vehicle has a profile, a state, and a mesh;
a profile list specifying a vehicle type for each of the plurality of intelligent vehicles;
a random number generator configured to generate random spawn points;
a spawn point list specifying a plurality of random spawn points for the plurality of intelligent vehicles; and
a timer configured to track the operational time of each of the plurality of intelligent vehicles.

86. A module as claimed in claim 85, further comprising a message manager configured to manage messages transmitted to the plurality of intelligent vehicles.

87. A module as claimed in claim 85, wherein the profile list further specifies an aggression level for each of the plurality of intelligent vehicles.

88. A module as claimed in claim 85, wherein the vehicle list specifies a mesh for each vehicle that includes at least one of a left front wheel mesh, a left rear wheel mesh, a right front wheel mesh, a right rear wheel mesh, and a vehicle mesh.

89. A driving simulator comprising:
an administrative module configured to access and review the operation of the driving simulator and to configure the driving simulator;
a graphics and sound rendering application configured to create and provide visual and audio data;
a history database configured to store operational data of the driving simulator;
an administrative database configured to store settings and configurations generated by the administrative module for operating the driving simulator;
a route database configured to store routes generated by the administrative module;
a tool module configured to provide modifying tools accessed by the administrative module;
a player module configured to replay stored operational data;
a simulator module configured to initiate and display a simulated driving environment and simulated vehicle; and
a manager module configured to manage objects of the driving simulator, to record operational data, and to provide an interface to the graphics and sound application.

90. A driving simulator as claimed in claim 89, wherein the administrative module is further configured to create a list of authenticated users.

91. A driving simulator as claimed in claim 90, wherein the administrative database is further configured to store the list of authenticated users.

92. A driving simulator as claimed in claim 89, wherein the administrative module is further configured to authenticate users.

93. A driving simulator as claimed in claim 89, wherein the administrative module is further configured to generate user assignments, wherein the user assignment include at least one of a simulated driving environment and a simulated vehicle.

94. A driving simulator as claimed in claim 93, wherein the administrative database is further configured to store user assignments generated by the administrative module.

95. A driving simulator as claimed in claim 89, further comprising a media database configured to store background images.

96. A driving simulator as claimed in claim 89, wherein the manager module is further configured to provide an interface to the graphics and sound application.

97. A driving simulator as claimed in claim 89, wherein the player module is further configured to record a plurality of frames displayed by the simulator module.

98. A driving simulator as claimed in claim 89, wherein the player module is further configured to record at least one trip time point.

99. A driving simulator as claimed in claim 98, wherein the player module is further configured to replay operational data starting at the at least one trip time point.

100. A driving simulator as claimed in claim 89, wherein the player module is further configured to record status information.

101. A driving simulator as claimed in claim 100, wherein the player module records status information including at least one of brake status, accelerator status, vehicle control status, and mirror check status.

102. A driving simulator as claimed in claim 100, wherein the player module is further configured to display status information.

103. A driving simulator as claimed in claim 89, wherein the player module is further configured to replay stored operational data from one or more camera angles.

104. A driving simulator as claimed in claim 103, wherein the player module is further configured to switch among the one or more camera angles while replaying the operational data.

105. A method of training a driver, the method comprising:
operating a computer-simulated vehicle through a computer-simulated driving environment;
recording the operation of the simulated vehicle through a simulated driving environment;
specifying a camera angle;
replaying the operation of a simulated vehicle through the simulated driving environment; and
modifying the camera angle.

106. A method as claimed in claim 105, further comprising setting up a simulated driving environment.

107. A method as claimed in claim 106, wherein setting up a simulated driving environment includes selecting a trip.

108. A method as claimed in claim 106, wherein setting up a simulated driving environment includes selecting trip parameters.

109. A method as claimed in claim 106, wherein setting up a simulated driving environment includes activating zero or more hazards.

110. A method as claimed in claim 106, wherein setting up a simulated driving environment includes selecting an aggression profile for a plurality of simulated intelligent vehicles.

111. A method as claimed in claim 105, further comprising setting up a simulated vehicle.

112. A method as claimed in claim 105, further comprising assigning a simulated driving environment to a user.

113. A method as claimed in claim 105, further comprising assigning a simulated vehicle to a user.

114. A method as claimed in claim 105, further comprising displaying status information while replaying the operation of the simulated vehicle.

115. A method as claimed in claim 105, further comprising scoring the operation of the simulated vehicle.

116. A method as claimed in claim 105, further comprising generating an infraction report during the operation of the simulated vehicle.

117. A method as claimed in claim 116, further comprising displaying the infraction report to the driver during the operation of the simulated vehicle.

118. A method as claimed in claim 105, further comprising generating a printable report based on the operation of the simulated vehicle.

119. A method of simulating a driving environment, the method comprising:
displaying a direct view of a computer-simulated driving environment in a direction; and
displaying one or more mirror views with the direct view upon indication by a user without modifying the direction of the direct view.

120. A method as claimed in claim 119, further comprising displaying the direct view of the simulated driving environment without at least one of the one or more mirror views upon another indication by the user without modifying the direction of the direct view.

121. A method as claimed in claim 119, wherein displaying one or more mirror views includes displaying at least one of a right-side mirror view and a left-side mirror view.

122. A method as claimed in claim 119, wherein displaying one or more mirror views includes displaying at least one mirror view that is different than the direct view.

123. A method of training a driver, the method comprising:
selecting a driver;
assigning a computer-simulated vehicle to the driver;
assigning a computer-simulated driving environment to the driver;
activating zero or more hazards;
specifying a likelihood of occurrence for each of the zero or more hazards;
selecting a risk factor for each of the zero or more hazards;
selecting trip parameters; and
specifying an aggression profile for a plurality of simulated intelligent vehicles.

124. A method as claimed in claim 123, further comprising operating the simulated vehicle through the simulated driving environment by the driver.

125. A method as claimed in claim 124, further comprising generating zero or more infraction reports during the operation of the simulated vehicle through the simulated driving environment by the driver.

126. A method as claimed in claim 125, further comprising displaying the zero or more infraction reports to the driver.

127. A method as claimed in claim 124, further comprising recording operation data during the operation of the simulated vehicle through the simulated driving environment.

128. A method as claimed in claim 127, further comprising replaying the operation data at a first camera angle.

129. A method as claimed in claim 128, further comprising replaying the operation data at a second camera angle, wherein the second angle is different from the first angle.

130. A method as claimed in claim 123, further comprising scoring the operation of the simulated vehicle by the driver through the simulated driving environment.

131. A method as claimed in claim 123, further comprising generating a printable report based on the operation of the simulated vehicle through the simulated driving environment.

132. A method for analyzing the operational data collected by a driving simulator, the method comprising:
storing the operational data in a storage device;
receiving report parameters from a user, wherein the user specifies a type of report including an individual trip report, a trip summary report, or a driver summary report;
obtaining the operational data from the storage device;
generating a report from the operational data; and
displaying the report to the user.

133. A method as claimed in claim 132, further comprising printing the report.

134. A method as claimed in claim 132, wherein receiving report parameters from a user includes receiving an individual trip report specification and a driver parameter and a trip parameter.

135. A method as claimed in claim 134, wherein obtaining the operational data from the storage device includes obtaining operation data associated with the driver parameter and trip parameter.

136. A method as claimed in claim 132, wherein receiving report parameters from a user includes receiving a trip summary report specification and a trip parameter.

137. A method as claimed in claim 136, wherein obtaining the operational data from the storage device includes obtaining operation data associated with the trip parameter.

138. A method as claimed in claim 132, wherein receiving report parameters from a user includes receiving a driver summary report specification and a driver parameter.

139. A method as claimed in claim 138, wherein obtaining the operational data from the storage device includes obtaining operation data associated with the driver parameter.
